(19) United States
(12) Patent Application Publication
(10) Pub. No.: US 2026/0201214 A1
(43) Pub. Date: Jul. 16, 2026

(54) ARTICLE INCLUDING A CURABLE ADHESIVE FILM AND A LINER AND PROCESSES FOR MAKING AND USING THE ARTICLE

(71) Applicant: 3M INNOVATIVE PROPERTIES COMPANY, St. Paul, MN (US)

(72) Inventors: Tzu-Yu Lai, Minneapolis, MN (US); Nichilas W. Lang, Minnetonka, MN (US); Alexander J. Kugel, Woodbury, MN (US); Dean A. Miner, Prescott, WI (US); Matthew T. Holbrook, Little Canada, MN (US); Scott M. Spear, St. Paul, MN (US); Kristen L. Bellmer, Cottage Grove, MN (US); Kerstin Unverhau, Neuss (DE); David T. Amos, St. Paul, MN (US)

(21) Appl. No.: 19/132,297

(22) PCT Filed: Nov. 22, 2023
(86) PCT No.: PCT/IB2023/061816

§ 371 Date: May 22, 2025

Related U.S. Application Data
(60) Provisional application No. 63/427,575, filed on Nov. 23, 2022.

(51) Int. Cl. C09J 7/40; C09J 11/06

(52) U.S. Cl. CPC C09J 7/405; C09J 11/06; C09J 2301/16; C09J 2400/24; C09J 2400/28; C09J 2423/00

(57) ABSTRACT

An article includes a curable adhesive film and an oxygen-permeable liner on at least one side of the curable adhesive film. The curable adhesive film includes a film of a polymer, unsaturated free-radically polymerizable groups, which may be bonded to the polymer or in a species other than the polymer, a transition metal cation, and an oxidizing agent. The article can further include a substrate or a release liner to which the curable adhesive film is attached. Processes for making the article and bonding the article are also described.

### CROSS-REFERENCE TO RELATED APPLICATION

This application claims priority to U.S. Provisional Application No. 63/427,575, filed Nov. 23, 2022, the disclosure of which is incorporated by reference in its entirety herein.

### BACKGROUND

U.S. Pat. Appl. Nos. 2020/0362204, 2021/0102095, and 2021/0102097, each to Ranade et al., each describe an adhesive system including a curable adhesive free-standing film comprising a blend of a) a first film-forming polymer or oligomer, b) a first species comprising first unsaturated free-radically polymerizable groups, which may be a) or a species other than a), and c) a first transition metal cation. The curable adhesive free-standing film may be a pressure sensitive adhesive. The curable adhesive free-standing film may be used with a primer that is liquid at normal temperature and pressure and includes an oxidizing agent. The curable adhesive free-standing film may also include d) a reducing agent; and no oxidizing agent and may be used in combination with a second curable adhesive free-standing film comprising a blend of e) a second film-forming polymer or oligomer; f) a second species comprising second unsaturated free-radically polymerizable groups, which may be e) or may be a species other than e); and g) an oxidizing agent. Methods of bonding using such a curable adhesive free-standing film are also described.

### SUMMARY

In one aspect, the present disclosure provides an article including a curable adhesive film and an oxygen-permeable liner on at least one side of the curable adhesive film. The curable adhesive film includes a film of a polymer, unsaturated free-radically polymerizable groups, which may be bonded to the polymer or in a species other than the polymer, a transition metal cation; and an oxidizing agent. In some embodiments, the article further comprises a release liner to which the curable adhesive film is releasably attached or a substrate to which the curable adhesive film is attached.

In another aspect, the present disclosure provides a process for making the aforementioned article including the substrate or the release liner. The process includes applying an activator to the substrate or the release liner, wherein the activator comprises the oxidizing agent, applying an adhesive film directly adjacent the activator on the substrate or the release liner to provide the curable adhesive film, wherein the adhesive film comprises the film of the polymer, the unsaturated free-radically polymerizable groups, and the transition metal cation, and joining the adhesive film with the oxygen-permeable liner.

In another aspect, the present disclosure provides a process for making a bonded article from the article including the substrate to which the curable adhesive film is attached. The method includes removing the oxygen-permeable liner and bonding a second substrate to the curable adhesive film.

In another aspect, the present disclosure provides a process for making a bonded article from two of the articles, each independently including the curable adhesive film, the oxygen-permeable liner, and the substrate to which the curable adhesive film is attached. The process includes removing the oxygen-permeable liner from each of the two articles and joining the curable adhesive films of the two articles together.

In another aspect, the present disclosure provides a process for making a bonded article from the article including the release liner to which the curable adhesive film is attached. The process includes removing the release liner to provide a first adhesive surface, removing the oxygen-permeable liner to provide a second adhesive surface, bonding the first adhesive surface to a first substrate, and bonding the second adhesive surface to a second substrate.

The term “polymer” refers to a molecule having a structure which includes the multiple repetition of units derived, actually or conceptually, from one or more monomers. The term “monomer” refers to a molecule of low relative molecular mass that can combine with others to form a polymer. The term “polymer” includes homopolymers and copolymers, as well as homopolymers or copolymers that may be formed in a miscible blend, e.g., by coextrusion or by reaction. The term “polymer” includes random, block, graft, and star polymers. The term “polymer” encompasses oligomers.

The terms “cure” and “curable” refer to joining polymer chains together by covalent chemical bonds, usually via crosslinking molecules or groups, to form a network polymer. Therefore, in this disclosure, the terms “cured” and “crosslinked” may be used interchangeably. A cured or crosslinked polymer is generally characterized by insolubility but may be swellable in the presence of an appropriate solvent. The term “crosslinked” includes partially crosslinked.

Oxygen permeable refers to having an oxygen permeability of a least 4000 centimeters cubed (cm³)*micrometer (μm)/meter squared (m²)*day*atmosphere (atm) (4000 cm³*μm/m²*day*atm) at 23° C. to 25° C. without a specified relative humidity percentage.

The term adjacent, as used throughout the description, refers to two superimposed layers within the tape or constructions including the tape, activator, and one or more substrates, which are arranged directly next to each other, i.e., which are abutting each other and are typically in direct contact with each other.

The term “film-forming” means capable of forming a continuous and coherent film, which in some embodiments may result from one or more of solidification, curing, drying, or solvent removal of a melt, solution, or suspension.

The term “free-standing film” means a film that is solid at normal temperature and pressure and has mechanical integrity independent of contact with any supporting material (which excludes, inter alia, liquids, surface coatings dried or cured in situ such as paints or primers, and surface coatings without independent mechanical integrity).

The term “hot melt processable” in the context of one of the polymer-containing layers or films described herein means the polymer-containing composition includes little or no conventional solvent (which is various embodiments may be less than 5 weight percent, less than 3 weight percent, less than 1 weight percent, less than 0.5 weight percent, less than 0.1 weight percent, or less than 0.01 weight percent of conventional solvent), which may be hot melt processed under conventional conditions, where hot melt processes include hot melt blending and extruding.

The term “(meth)acrylate” includes, separately and collectively, methacrylate and acrylate.

The term “monomer unit” of a polymer or oligomer is a segment of a polymer or oligomer derived from a single monomer.

The term “normal temperature and pressure” or “NTP” means a temperature of 20° C. (293.15 K, 68° F.) and an absolute pressure of 1 atm (14.696 psi, 101.325 kPa).

The term “pendant” in the context of functional groups of a polymer or oligomer are functional groups that do not form a part of the backbone of the polymer or oligomer and are not terminal groups of the polymer.

The term “structural adhesive” means an adhesive that binds by irreversible cure, typically with a strength when bound to its intended substrates, measured as stress at break (peak stress) using the Dynamic Shear Adhesion Test described in the Examples Section, of at least 4.52 MPa (655 psi), more typically at least 5.36 MPa (777 psi), and in some embodiments at least 6.29 MPa (912 psi). “Pressure sensitive adhesives” (PSAs) are well known to those of ordinary skill in the art to possess properties including the following: (1) aggressive and permanent tack, (2) adherence with no more than finger pressure, (3) sufficient ability to hold onto an adherend, and typically, (4) sufficient cohesive strength to be cleanly removable from the adherend. PSAs are tacky and have the ability to adhere without activation by any energy source such as light, heat, or a chemical reaction. Materials that have been found to function well as PSAs are polymers designed and formulated to exhibit the requisite viscoelastic properties resulting in a desired balance of tack, peel adhesion, and shear holding power. One method useful for identifying pressure sensitive adhesives is the Dahlquist criterion. This criterion defines a pressure sensitive adhesive as an adhesive having a creep compliance of greater than 3×10⁻⁶ cm²/dyne as described in Handbook of Pressure Sensitive Adhesive Technology, Donatas Satas (Ed.), 2nd Edition, p. 172, Van Nostrand Reinhold, New York, NY, 1989. Alternatively, since modulus is, to a first approximation, the inverse of creep compliance, pressure sensitive adhesives may be defined as adhesives having a storage modulus of less than about 3×10⁵ N/m².

The term “glass transition temperature” or “Tg” refers to the temperature at which a material changes from a glassy state to a rubbery state. In this context, the term “glassy” means that the material is hard and brittle (and therefore relatively easy to break) while the term “rubbery” means that the material is elastic and flexible. For polymeric materials, the Tg is the critical temperature that separates their glassy and rubbery behaviors. If a polymeric material is at a temperature below its Tg, large-scale molecular motion is severely restricted because the material is essentially frozen. On the other hand, if the polymeric material is at a temperature above its Tg, molecular motion on the scale of its repeat unit takes place, allowing it to be soft or rubbery. Any reference herein to the Tg of a monomer refers to the Tg of a homopolymer formed from that monomer. The glass transition temperature of a polymeric material is often determined using methods such as Dynamic Mechanical Analysis (“DMA”) or Differential Scanning Calorimetry (e.g., Modulated Differential Scanning Calorimetry). Alternatively, the glass transition of a polymeric material can be calculated using the Fox Equation if the amount and Tg of each monomer used to form the polymeric material are known.

The term “alkyl” refers to a monovalent group which is a saturated hydrocarbon. The alkyl can be linear, branched, cyclic, or combinations thereof, and typically has 1 to 32 carbon atoms. Unless otherwise indicated, the alkyl group contains 1 to 25, 1 to 20, 1 to 18, 1 to 12, 1 to 10, 1 to 8, 1 to 6, or 1 to 4 carbon atoms. Examples of alkyl groups include methyl, ethyl, n-propyl, isopropyl, n-butyl, isobutyl, tert-butyl, n-pentyl, n-hexyl, cyclohexyl, n-heptyl, n-octyl, 2-ethylhexyl, 2-octyl and 2-propylheptyl.

The term “aryl” refers to a monovalent group that is aromatic and, optionally, carbocyclic. The aryl has at least one aromatic ring. Any additional rings can be unsaturated, partially saturated, saturated, or aromatic. Optionally, the aromatic ring can have one or more additional carbocyclic rings that are fused to the aromatic ring. Unless otherwise indicated, the aryl groups typically contain from 6 to 30 carbon atoms. In some embodiments, the aryl groups contain 6 to 20, 6 to 18, 6 to 16, 6 to 12, or 6 to 10 carbon atoms. Examples of an aryl group include phenyl, naphthyl, biphenyl, phenanthryl, and anthracyl.

The term “aralkyl” refers to a monovalent group that is an alkyl substituted with an aryl group (e.g., as in a benzyl group). The term “alkaryl” refers to a monovalent group that is an aryl substituted with an alkyl group (e.g., as in a tolyl group). In some embodiments, for both groups, the alkyl portion has 1 to 10 carbon atoms, 1 to 6 carbon atoms, or 1 to 4 carbon atoms, and an aryl portion has 6 to 20 carbon atoms, 6 to 18 carbon atoms, 6 to 16 carbon atoms, 6 to 12 carbon atoms, or 6 to 10 carbon atoms.

The term “alkylene” refers to a divalent group that is a radical of an alkane and includes groups that are linear, branched, cyclic, bicyclic, or a combination thereof. Unless otherwise indicated, the alkylene group typically has 1 to 30 carbon atoms. In some embodiments, the alkylene group has 1 to 20 carbon atoms, 1 to 10 carbon atoms, 1 to 6 carbon atoms, or 1 to 4 carbon atoms. Examples of “alkylene” groups include methylene, ethylene, propylene, 1,4-butylene, 1,4-cyclohexylene, and 1,4-cyclohexyldimethylene.

The term “arylene” refers to a divalent group that is aromatic and, optionally, carbocyclic. The arylene has at least one aromatic ring. Optionally, the aromatic ring can have one or more additional carbocyclic rings that are fused to the aromatic ring. Any additional rings can be unsaturated, partially saturated, or saturated. In some embodiments, the arylene group has up to 5 rings, up to 4 rings, up to 3 rings, up to 2 rings, or one aromatic ring. For example, the arylene group can be phenylene. Unless otherwise specified, arylene groups have 6 to 20 carbon atoms, 6 to 18 carbon atoms, 6 to 16 carbon atoms, 6 to 12 carbon atoms, or 6 to 10 carbon atoms.

The term “aralkylene” refers to a divalent group that is an alkylene group substituted with an aryl group or an alkylene group attached to an arylene group. The term “alkarylene” refers to a divalent group that is an arylene group substituted with an alkyl group or an arylene group attached to an alkylene group.

In some embodiments, for both groups, the alkyl or alkylene portion has from 1 to 20 carbon atoms, 1 to 10 carbon atoms, 1 to 6 carbon atoms, or 1 to 4 carbon atoms. In some embodiments, for both groups, the aryl or arylene portion has from 6 to 20 carbon atoms, 6 to 18 carbon atoms, 6 to 16 carbon atoms, 6 to 12 carbon atoms, or 6 to 10 carbon atoms.

As used herein, the term “or” is generally employed in its usual sense including “and/or” unless the content clearly dictates otherwise. As used herein, the term “and/or” is used to indicate one or both stated cases may occur, for example A and/or B includes, (A and B) and (A or B).

As used herein, the term “room temperature” refers to a temperature in the range of 20° C. to 25° C.

Herein, the term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements. Any of the elements or combinations of elements that are recited in this specification in open-ended language (e.g., comprise and derivatives thereof), are considered to additionally be recited in closed-ended language (e.g., consisting of and derivatives thereof) and in partially closed-ended language (e.g., consisting essentially of, and derivatives thereof).

In this application, terms such as “a,” “an,” and “the” are not intended to refer to only a singular entity but include the general class of which a specific example may be used for illustration. The terms “a,” “an,” and “the” are used interchangeably with the term “at least one.” The phrases “at least one of” and “comprises at least one of” followed by a list including the conjunction “or” refers to any one of the items in the list and any combination of two or more items in the list.

Also herein, all numbers are assumed to be modified by the term “about” and in certain embodiments, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.) and any sub-ranges (e.g., 1 to 5 includes 1 to 4, 1 to 3, 2 to 4, etc.).

The term “in the range” or “within a range” (and similar statements) includes the endpoints of the stated range.

Reference throughout this specification to “some embodiments,” means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter. The drawings are not to scale.

### BRIEF DESCRIPTION OF THE DRAWINGS

FIG. 1 is a cross section of one embodiment of an article of the present disclosure.

FIG. 2 is a cross section of another embodiment of an article of the present disclosure.

FIG. 3 is a cross section of one embodiment of a curable adhesive film useful in the article of the present disclosure.

FIG. 4 depicts an embodiment of a process for bonding two substrates using an embodiment of the article of the present disclosure.

FIG. 5 depicts another embodiment of a process for bonding two substrates using an embodiment of the article of the present disclosure.

FIG. 6 depicts yet another embodiment of a process for bonding two substrates using another embodiment of the article of the present disclosure.

### DETAILED DESCRIPTION OF ILLUSTRATIVE EMBODIMENTS

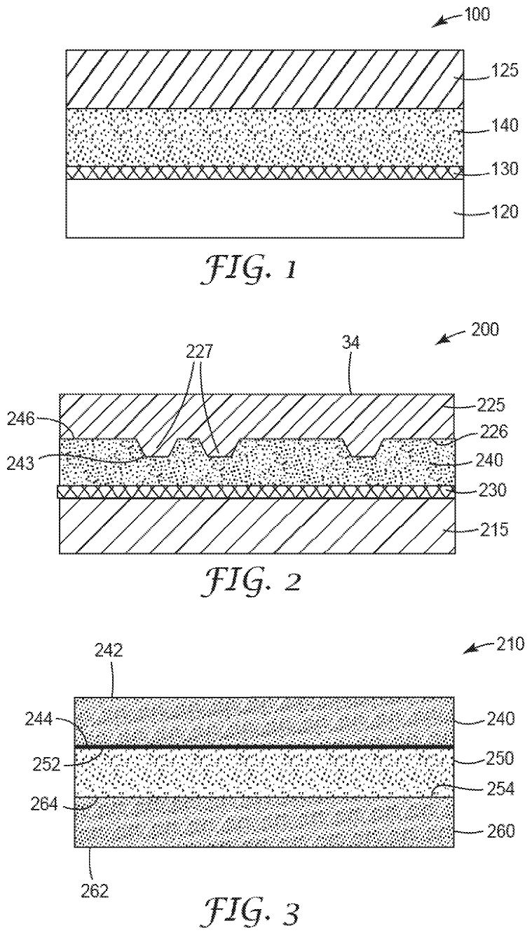

A cross section of an embodiment of an article of the present disclosure is shown in FIG. 1. The article 100 includes a curable adhesive film 140 and an oxygen-permeable liner 125 on at least one side of the curable adhesive film. The curable adhesive film 140 comprises a film of a polymer, unsaturated free-radically polymerizable groups, which may be bonded to the polymer or in a species other than the polymer, a transition metal cation, and an oxidizing agent. The embodiment illustrated in FIG. 1 also includes a substrate 120. The illustrated embodiment may be made by a process including applying an activator 130 to the substrate 120, wherein the activator comprises the oxidizing agent, applying an adhesive film directly adjacent the activator 130 on the substrate 120 to provide the curable adhesive film 140, and joining the adhesive film with the oxygen-permeable liner. The adhesive film comprises the film of the polymer, the unsaturated free-radically polymerizable groups, and the transition metal cation. Typically, the oxidizing agent of the activator 130 migrates into the adhesive film to provide the curable adhesive film 140. However, curing of the curable adhesive film is inhibited by oxygen. Therefore, while the oxygen-permeable liner is in place, the curable adhesive film does not cure for a period of several days or several weeks. In some embodiments, the process of making the illustrated embodiment includes forming the adhesive film on the oxygen-permeable liner and applying an adhesive film directly adjacent the activator while the adhesive film is in contact with the oxygen-permeable liner.

A cross section of another embodiment of an article of the present disclosure is shown in FIG. 2. The article 200 includes a curable adhesive film 240 and an oxygen-permeable liner 225 on at least one side of the curable adhesive film. The curable adhesive film 240 comprises a film of a polymer, unsaturated free-radically polymerizable groups, which may be bonded to the polymer or in a species other than the polymer, a transition metal cation, and an oxidizing agent. In the embodiment illustrated in FIG. 2, the oxygen-permeable liner 225 comprises ridges 227 on at least one surface 226. The height of the ridges may be in a range from 4 micrometers (m) to 200 μm, from 8 μm to 100 μm, or from 10 μm to 30 μm. In these embodiments, the ridges can be considered microstructures. The ridges may be in regular patterns or may appear randomly spaced and may have a variety of cross-sectional shapes. The curable adhesive film 240 includes channels 243 corresponding to the ridges 227 in surface 246. Such channels are capable of aiding in the escape of air during the later application of the surface 246 to a substrate. The channels, and methods of their production, may be as taught in U.S. Pat. No. 6,655,281 (Jordan et al.).

The embodiment illustrated in FIG. 2 also includes a release liner 215. The illustrated embodiment may be made by applying an activator 230 to the release liner 215, wherein the activator comprises the oxidizing agent. The adhesive film including the film of the polymer, the unsaturated free-radically polymerizable groups, and the transition metal cation, conveniently formed on the oxygen-permeable liner including ridges, can then be applied directly adjacent the activator 230 on the release liner to provide the curable adhesive film 240. Typically, the oxidizing agent of the activator 230 migrates into the adhesive film to provide the curable adhesive film 240. However, curing of the curable adhesive film is inhibited by oxygen. Therefore, while the oxygen-permeable liner is in place, the curable adhesive film does not cure for a period of several days or several weeks. Although not shown in the embodiment illustrated in FIG. 2, air bleed channels 243 may also be formed in the opposing surface of the adhesive film, which may help to improve contact when it is applied to the activator.

In some embodiments, the curable adhesive film is a first layer of a multilayer curable adhesive film, wherein the multilayer curable adhesive film further comprises a support layer. In some embodiments, the support layer is a foam support layer, in some embodiments, a curable foam support layer. In some embodiments, the multilayer curable adhesive film is a double-sided tape with one curable adhesive film adjacent each major surface of a curable foam support layer (i.e., a second curable adhesive film is adjacent the surface opposite the first curable adhesive film). Thus, in this embodiment, a first curable adhesive film is adjacent to a first major surface of a curable foam support layer, and a second curable adhesive film is adjacent to a second major surface of the curable foam support layer.

As shown in FIG. 3, an embodiment of a multilayer curable adhesive film 210 includes a first curable adhesive film 240 (having two major surfaces 242 and 244), and a second curable adhesive film 260 (having two major surfaces 262 and 264), each of which are adjacent to opposite surfaces of a curable foam support layer 250 (having two major surfaces 252 and 254). More specifically, the first major surfaces 242 and 262 form the outer adhesive surfaces of multilayer curable adhesive film 210; the second major surface 244 of the first adhesive film 240 is adjacent the first major surface 252 of the foam support layer 250; and the second major surface 264 of the second adhesive film 260 is adjacent the second major surface 254 of the foam support layer 250.

The second layer is a second curable adhesive film comprising a second film of a second polymer, second unsaturated free-radically polymerizable groups, which may be which may be bonded to the second polymer or in a second species other than the second polymer, and a second transition metal cation. The components of the first and second curable adhesive films may be the same or different. In some embodiments, the second unsaturated free-radically polymerizable groups are bonded to the second polymer. In some embodiments, the second unsaturated free-radically polymerizable groups are in a second species other than the second polymer, and the second polymer does not comprise unsaturated free-radically polymerizable groups.

In some embodiments of FIG. 3, the first curable adhesive film 240 is borne on a first major surface 252 of the curable foam support layer 250, and the second curable adhesive film 260 is borne on a second major surface 254 of the curable foam support layer 250. That is, the layers are typically made in one step, such as occurs in a coating or coextrusion process. In some embodiments of FIG. 3, the first curable adhesive film 240 is directly bound to a first major surface 252 of the curable foam support layer 250 and the second curable adhesive film 260 is directly bound to a second major surface 254 of the curable foam support layer 250. That is, the layers are typically made in two or more steps, such as occurs in a lamination process. Such procedures are well-known in the preparation of tapes. However the multilayer curable adhesive film is made, a major surface 244 of the curable adhesive film 240 is adjacent to a major surface 252 of the curable foam support layer 250.

The multilayer curable adhesive film 210 can be used as the curable adhesive film 140, 240, for example, in the embodiments shown in FIGS. 1 and 2. When made by a process including applying an activator, which includes an oxidizing agent, to a substrate as described above typically, the oxidizing agent of the activator migrates into the curable adhesive films 240, 260 and the curable foam support layer 250, thereby initiating cure of both the curable adhesive films 240, 260 and the curable foam support layer 250.

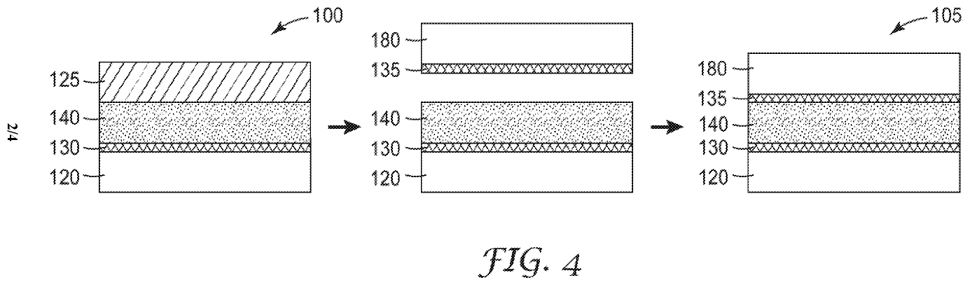

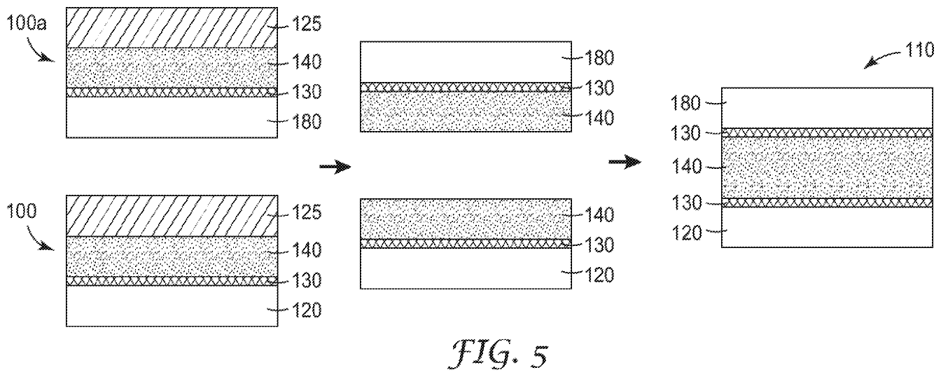

The present disclosure provides a process for making a bonded article 105. FIG. 4 illustrates an embodiment of such a process for bonding two substrates using the article 100 shown in FIG. 1. The process illustrated in FIG. 4 includes removing oxygen-permeable liner 125 to expose curable adhesive film 140. Although not illustrated in FIG. 4, curable adhesive film 140 may also be the first layer of a multilayer curable adhesive film 210 as shown in FIG. 3. After removing oxygen-permeable liner 125, the process includes bonding second substrate 180 to curable adhesive film 140. In some embodiments, the bonded article is held by external forces, e.g., a clamp, until the curable adhesive film becomes cured; however, in other embodiments tackiness of the curable adhesive film alone holds the assembly until the curable adhesive film becomes cured. Once cured, the curable adhesive film 140 provides a structural adhesive layer.

In some embodiments of the process for making bonded article 105, the process further comprises applying an activator 135 to the second substrate 180 before bonding second substrate 180 to curable adhesive film 140. Optional activator 135 comprises a second oxidizing agent, wherein the second oxidizing agent is the same or different from the oxidizing agent in the curable adhesive film.

Typically, the oxidizing agent of the activator 135 migrates into the curable adhesive film 140 to participate in curing the curable adhesive film 140 to form a structural adhesive layer. After curing, bonded article 105 includes first and second substrates 120, 180 bonded together with a structural adhesive made from activator 130, curable adhesive film 140, and optional activator 135.

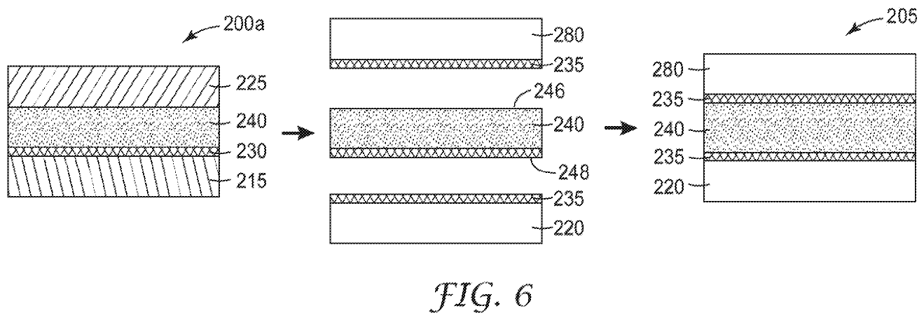

FIG. 5 illustrates another embodiment of a process for making a bonded article 110 including two substrates using the article 100 shown in FIG. 1. The process illustrated in FIG. 5 includes removing oxygen-permeable liner 125 from two articles 100, 100a to expose curable adhesive film 140 on both articles 100. The two articles 100 may be the same or different from each other, including first and second substrates 120, 180, which may be the same or different from each other, curable adhesive films 140, which may be the same or different from each other, and oxygen-permeable liners 125, which may be the same or different from each other. Although not illustrated in FIG. 5, one or more of the curable adhesive films 140 may also be the first layer of a multilayer curable adhesive film 210 as shown in FIG. 3. As shown in FIG. 5, the curable adhesive films 140 are positioned to contact each other once the oxygen-permeable films are removed and then bonded together. In some embodiments, the bonded article is held by external forces, e.g., a clamp, until the curable adhesive film becomes cured; however, in other embodiments tackiness of the curable adhesive film alone holds the assembly until the curable adhesive film becomes cured. Once cured, the curable adhesive film 140 provides a structural adhesive layer.

FIG. 6 illustrates another embodiment of a process for making a bonded article 110 including two substrates using an embodiment of the article similar to that shown in FIG. 2 except that no ridges 227 or channels 243 are shown in FIG. 6. Although not illustrated in FIG. 6, curable adhesive film 140 may also be the first layer of a multilayer curable adhesive film 210 as shown in FIG. 3. The process illustrated in FIG. 6 includes removing the release liner 215 to provide a first adhesive surface 248, removing the oxygen-permeable liner 225 to provide a second adhesive surface 246, bonding the first adhesive surface 248 to a first substrate 220, and bonding the second adhesive surface 246 to a second substrate 280.

Removing oxygen-permeable liner 225 and release liner 215 may be carried out simultaneously or sequentially in any order. Likewise, bonding first adhesive surface 248 to a first substrate 220 and bonding second adhesive surface 246 to a second substrate 280 can be carried out simultaneously or sequentially in any order. Bonding first adhesive surface 248 to a first substrate 220 can be carried out before removing the oxygen-permeable liner 225, or bonding second adhesive surface 246 to a second substrate 280 can be carried out before removing release liner 215. In some embodiments, the bonded article is held by external forces, e.g., a clamp, until the curable adhesive film becomes cured; however, in other embodiments, tackiness of the curable adhesive film alone holds the assembly until the curable adhesive film becomes cured. Once cured, the curable adhesive film 240 provides a structural adhesive layer.

In some embodiments of the process for making bonded article 205, the process further comprises applying activator 235 to at least one of first substrate 220 or second substrate 280 before bonding first and second adhesive surfaces 248, 246 to first and second substrates 220, 280, respectively.

In some embodiments, activator 235 is applied to only one of the first substrate 220 or the second substrate 280. In some embodiments, activator 235 is applied to both the first substrate 220 and the second substrate 280. Optional activator 235 comprises a second oxidizing agent, wherein the second oxidizing agent is the same or different from the oxidizing agent in the curable adhesive film. The activators 235 and their components applied to first substrate 220 and second substrate 280 may be the same or different. Typically, the oxidizing agent of the activator 235 migrates into the curable adhesive film 240 to participate in curing the curable adhesive film 240 to form a structural adhesive layer.

The embodiment illustrated in FIG. 6 does not include ridges on the oxygen-permeable liner 225 or the release liner 215. In other embodiments, one or both of oxygen-permeable liner 225 or release liner 215 has ridges on a surface that contacts curable adhesive film 240 to provide channels in the curable adhesive film. Returning to FIG. 2, when a curable adhesive film has channels 243 in one surface 246 and not the other, the surface without channels may be placed on a first substrate 220 and the second substrate 280 may then be brought into contact with the surface 246 including channels. This approach may be useful, for example, when two stiff substrates are to be joined, since it allows air bleed and adaptability to uneven surfaces despite the inflexibility of the substrates.

In the embodiments illustrated in FIGS. 1 to 6, the processes of the present disclosure do not require mixing of liquid components; rather, the activator is applied to a substrate or release liner, and the activator-coated substrate or release liner is contacted with the curable adhesive film 140, 210, or 240, into which the oxidizing agent from the activator migrates. In other embodiments, the oxidizing agent can be combined with the polymer, the unsaturated free-radically polymerizable groups, and the transition metal cation when the film of the polymer is made in the presence of oxygen. The oxygen-permeable liner can be kept in place on the curable adhesive film until the curable adhesive film is ready to bond. Upon removal of the oxygen-permeable film and joining of the substrates, thereby excluding oxygen, the curable adhesive film begins to cure, resulting in structural adhesive bonds. In some embodiments of the processes of the present disclosure, cure can be achieved at normal temperature and pressure, without heat or autoclave. Likewise, in some embodiments of the processes of the present disclosure, cure can be achieved without UV or other radiation treatment, and cure propagates well to areas inaccessible to radiation cure. In some embodiments of the present articles and processes, the articles of the present disclosure need not be refrigerated or kept in dark storage.

Any oxygen-permeable liner that allows sufficient oxygen to pass through to inhibit the curing of the unsaturated free-radically polymerizable groups may be useful in the articles and processes of the present disclosure. Suitable materials for a liner include paper, polyvinyl chloride (PVC), polylactic acid (PLA), polyhydroxyalkanoates (PHA), polyhydroxybutyrate (PHB), polystyrene (PS), and polyolefins (e.g., polypropylene, high density polyethylene (HDPE), low density polyethylene (LDPE), biaxially oriented polypropylene (BOPP)). In some embodiments, the oxygen-permeable liner comprises at least one of paper or a polyolefin. The oxygen-permeable liner may have a low-adhesion surface provided, for example, by a silicone, a fluoropolymer, a carbamate, an acrylic, a urethane, or a polyolefin. Examples of useflul release agents that may, in some embodiments, he coated on the oxygen-permeable liner include silicone copolyners (e.g. silicone acrylates, silicone polvurethanes, and silicone polyureas), fluorosilicones, periluoropolvethers, polyethylene, polypropylene, low-density polyethylene), and combinations thereof. In some embodiments, the oxygen-permeable liner is poly coated kraft paper (i.e., paper coated with polyethylene), which may or may not be silicone-coated.

In some embodiments, the curable adhesive film is stable at room temperature for at least two weeks. Advantageously, as shown in the Examples below, an article of the present disclosure can be made by applying an activator to a first aluminum substrate followed by an adhesive film covered with an oxygen-permeable liner. Once the oxygen-permeable liner is removed and the curable adhesive film is brought into contact with a second aluminum substrate with or without having an applied activator layer, the tape cures, and a structural adhesive is formed as evidenced by the overlap shear data in Tables 1 and 2. Also as shown in Tables 1 and 2, the overlap shear strength provided by the curable adhesive film remains stable for a period of three days up to three weeks while the oxygen-permeable liner remains on the curable adhesive film. In some embodiments, applying the curable adhesive film covered with an oxygen-permeable liner is carried out at least 1, 3, or 5 days or at least 1, 2, 3, or 4 weeks before removing the oxygen-permeable liner and bonding the curable adhesive film to the second substrate. Thus, it is possible to apply the curable adhesive film to a substrate at a first time or location and bond it to a second substrate at a later time or different location, providing flexibility in making bonded articles using the articles and processes of the present disclosure.

While it is possible that a curable adhesive film containing no oxidizing agent may be attached to a first substrate at the point of manufacture, and an activator including an oxidizing agent may be applied to a second substrate and at a second point of manufacture, and the first substrate and the activated second substrate may be bonded at the second point of manufacture or even at a third time and/or place, the articles and processes of the present disclosure provide even greater flexibility, since it is possible that second substrate may not even need to be activated to achieve adequate bonding. Moreover, allowing more time for the oxidizing agent to migrate throughout the curable adhesive film while it is covered with an oxygen-permeable liner may provide stronger structural adhesive bonds more quickly once the oxygen-permeable liner is removed and the curable adhesive film is bonded to the second substrate.

While U.S. Pat. Appl. Nos. 2020/0362204, 2021/0102095, and 2021/0102097, each to Ranade et al., describe an adhesive system as described above in a construction that includes a release liner, the purpose of the release liner is to exclude oxygen. The release liner is said to preferably be left in place until cure is complete. The ability of the oxygen-permeable liner in the article of the present disclosure to provide two or more weeks of stability of the curable adhesive film, which includes the unsaturated free-radically polymerizable groups, the transition metal cation, and the oxidizing agent, is quite unexpected. Herein, when it is said that the curable adhesive film is stable at room temperature for at least two weeks, it means that the dynamic shear adhesion on aluminum, measured as described in the Examples below, does not fall to lower than 90% of the initial adhesion value, measured on the day the curable adhesive film is applied to the activator.

The substrates in the articles and processes of the present disclosure, as described above and below in any of their embodiments, may be composed of any suitable material. Suitable substrate materials include metals (e.g., aluminum, titanium, stainless steel, and steel), polymeric materials (e.g., polyolefins, polyethylenes, polypropylenes, polystyrenes, poly(meth)acrylates, polyurethanes, natural or synthetic rubbers, and polydienes), natural materials (e.g., wood and stone) or derivatives thereof (e.g., composite board and concrete), glass material, and ceramic materials. If two substrates are bonded together in the articles and processes of the present disclosure, the two substrates are independently selected.

In some embodiments, at least one of the surfaces of the first substrate or the surface of the second substrate comprises at least one of metal, glass, a polymer, paper, a painted surface, a nonwoven or woven fabric, wood, foam, or a composite. The material of the surface of the first and second substrate may be found throughout the substrate, or the surface may include a different material from the bulk of the substrate. In some embodiments, the surface of the first substrate and/or second substrate comprises at least one of metal (e.g., steel, stainless steel, or aluminum), glass (e.g., which may be coated with indium tin oxide, for example,), a polymer (e.g., a plastic, rubber, thermoplastic elastomer, or thermoset), paper, a painted surface, or a composite. A composite material may be made from any two or more constituent materials with different physical or chemical properties. When the constituents are combined to make a composite, a material having characteristics different from the individual components is typically achieved. Some examples of useful composites include fiber-reinforced polymers (e.g., carbon fiber reinforced epoxies and glass-reinforced plastic); metal matrix compositions; and ceramic matrix composites. The surface of at least one of the first or second substrates may include polymers such as polyolefins (e.g., polypropylene, polyethylene, high density polyethylene, blends of polypropylene), polyamide 6 (PA6), acrylonitrile butadiene styrene (ABS), polycarbonate (PC), PC/ABS blends, polyvinyl chloride (PVC), polyamide (PA), polyurethane (PUR), thermoplastic elastomers (TPE), polyoxymethylene (POM), polystyrene, polyester (e.g., polyethylene terephthalate), poly(methyl) methacrylate (PMMA), and combinations thereof. The surface of at least one of the first or second substrate may also include a metal coating on such polymers. In some embodiments, at least one of the first or second substrate comprises a transparent material such as glass or a polymer (e.g., acrylic or polycarbonate).

The release liner, as described above in connection with FIGS. 2 and 6, may be an oxygen-permeable liner as describe above in any of its embodiments. However, the release liner need not be oxygen-permeable and can include other materials, for example, ethylene vinyl acetate, polyurethanes, cellulose acetate, polyvinylidene fluoride, and polyesters such as polyethylene terephthalate. The release liner may be coated with a layer of a release agent such as a silicone, a fluoropolymer, a carbamate, an acrylic, or a polyolefin, including any of those described above in connection with the oxygen-permeable liner. Coatings may be present on both sides of a release liner, and these liners may be the same or different. Suitable release liners include commercially available liners that have a silicone release coating on polyethylene terephthalate film. The release liner can have ridges on its surface as described above in any of their embodiments in connection with the oxygen-permeable liner.

The curable adhesive film of the article of the present disclosure includes a film of a polymer, unsaturated free-radically polymerizable groups, a transition metal cation, and an oxidizing agent. The unsaturated free-radically polymerizable groups, which may be bonded to the polymer (i.e., a component of the polymer) or may be in a species other than the polymer. In some embodiments, the curable adhesive film also includes a redox accelerator. The unsaturated free-radically polymerizable groups serve to crosslink the curable adhesive film.

Examples of suitable film-forming polymers useful for the polymer film in the curable adhesive film include (meth)acrylate polymers; aromatic or aliphatic polyurethanes (e.g., including those polyurethanes made with aliphatic or aromatic diols, polyamides, saturated and unsaturated polyesters, such as polybutylene terephthalate, polyethylene terephthalate, polyglycolic acid, polylactic acid, poly-2-hydroxy butyrate, polycaprolactone, and combinations containing maleic acid repeating units); polyethers (e.g., such as polyacetal and its copolymers, polyphenylene oxide, polyetherketone, polyetheretherketone); natural and synthetic rubbers (e.g., polyisoprene, polychloroprene, nitrile rubber, butadiene-based rubbers); alkyds; phenolic resins (e.g., novolacs and resoles); amino resins (e.g., urea-formaldehyde resins, melamine-formaldehyde resins, and melamine-urea copolymer resins); and epoxies (e.g., those made from Bisphenol A or adducts using telechelic amino resins capped with oxirane functional groups). In some embodiments, the film-forming polymer or oligomer is a (meth)acrylate functional polymer, such as that made by adding (meth)acrylate end groups to polyester, polyurethane, polybutadiene, or polyether polymers. Various combinations of any of these film-forming polymers may be useful in the curable adhesive film in the article of the present disclosure.

In some embodiments, the film-forming polymer of the curable adhesive film is a (meth)acrylate polymer. In some embodiments, the curable adhesive films are pressure sensitive adhesives while they are in contact with the oxygen-permeable liner. As such, they are capable of maintaining substrates in position before cure, for example, under shop or factory conditions, without clamps or other supports. In some embodiments in which the curable adhesive film is a (meth)acrylate polymer and/or a pressure sensitive adhesive, the (meth)acrylate polymer comprises linear or branched alkyl (meth)acrylate ester monomer units selected from the group consisting of methyl (meth)acrylate, ethyl (meth)acrylate, n-propyl (meth)acrylate, isopropyl (meth)acrylate, n-butyl acrylate, isobutyl acrylate, tert-butyl (meth)acrylate, n-pentyl (meth)acrylate, iso-pentyl (meth)acrylate, n-hexyl (meth)acrylate, iso-hexyl (meth)acrylate, cyclohexyl (meth)acrylate, phenyl (meth)acrylate, octyl (meth)acrylate, iso-octyl (meth)acrylate, 2-octyl(meth)acrylate, 2-ethylhexyl (meth)acrylate, decyl (meth)acrylate, undecyl (meth)acrylate, lauryl (meth)acrylate, tridecyl (meth)acrylate, tetradecyl (meth)acrylate, pentadecyl (meth)acrylate, hexadecyl (meth)acrylate, heptadecyl (meth)acrylate, 2-propylheptyl (meth)acrylate, stearyl (meth)acrylate, isobornyl (meth)acrylate, benzyl (meth)acrylate, nonyl (meth)acrylate, isophoryl (meth)acrylate, and any combinations or mixtures thereof. In some embodiments, the (meth)acrylate polymer includes monomer units of at least one of 2-methylbutyl acrylate, isooctyl acrylate, lauryl acrylate, 4-methyl-2-pentyl acrylate, isoamyl acrylate, sec-butyl acrylate, n-butyl acrylate, n-hexyl acrylate, 2-ethylhexyl acrylate, n-octyl acrylate, n-decyl acrylate, isodecyl acrylate, isodecyl methacrylate, or isononyl acrylate.

Suitable monomer units further include mixtures of at least two or at least three structural isomers of a secondary alkyl (meth)acrylate of Formula I:

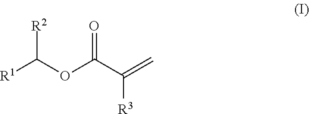

wherein R¹ and R² are each independently a C₁ to C₃₀ saturated linear alkyl group; the sum of the number of carbons in R¹ and R² is 7 to 31; and R³ is H or CH₃. The sum of the number of carbons in R¹ and R² can be, in some embodiments, 7 to 27, 7 to 25, 7 to 21, 7 to 17, 7 to 11, 7, 11 to 27, 11 to 25, 11 to 21, 11 to 17, or 11. Methods for making and using such monomers and monomer mixtures are described in U.S. Pat. No. 9,102,774 (Clapper et al.).

In some embodiments, the alkyl (meth)acrylate ester monomer units may be copolymerized with one or more monoethylenically unsaturated monomers that have polar groups such as acrylic acid, methacrylic acid, itaconic acid, acrylamide, methacrylamide, N-substituted acrylamides (for example, N,N-dimethyl acrylamide), acrylonitrile, methacrylonitrile, hydroxyalkyl acrylates, cyanoethyl acrylate, N-vinylpyrrolidone, N-vinylcaprolactam, and maleic anhydride. In some embodiments, these polar copolymerizable monomers are used in amounts of less than 20% by weight and/or at least 6%, at least 8%, or at least 10%, based on the total weight of the monomer units. In some embodiments, the (meth)acrylate polymer comprises at least 6% by weight acrylic acid, at least 8% by weight, or at least 10% by weight acrylic acid, each based on the total weight of the monomers in the (meth)acrylate polymer. In some embodiments, the (meth)acrylate polymer includes from 0.1 weight percent to 12 weight percent of (meth)acrylic acid monomer units, based on the weight of the (meth)acrylate polymer. The (meth)acrylate polymer may also include small amounts of other useful copolymerizable monoethylenically unsaturated monomers such as alkyl vinyl ethers, vinylidene chloride, styrene, and vinyltoluene.

In some embodiments, the alkyl (meth)acrylate ester monomer units may be copolymerized with a crosslinking agent, such as 1,6-hexanediol diacrylate or with a photoactive triazine crosslinking agent such as taught in U.S. Pat. No. 4,330,590 (Vesley) and U.S. Pat. No. 4,329,384 (Vesley et al). Film-forming polymers can also be crosslinked with a heat-activatable crosslinking agent such as a lower-alkoxylated amino formaldehyde condensate having C₁₋₄ alkyl groups, for example, hexamethoxymethyl melamine or tetramethoxymethyl urea or tetrabutoxymethyl urea. Crosslinking the film-forming polymer may also be achieved by irradiating the composition with electron beam (or “e-beam”) radiation, gamma radiation, or x-ray radiation. This crosslinking occurs in the preparation of the film of the polymer, which occurs before reaction of unsaturated free-radically polymerizable groups in the curable adhesive film.

In some embodiments, the (meth)acrylate polymer has a Tg of no greater than 0° C. In some embodiments, the (meth)acrylate polymer has a Tg of −70° C. to 0° C., −70° C. to −10° C., −60° C. to −10° C., −60° C. to −20° C., −60° C. to −30° C., −55° C. to −35° C., or −50° C. to −40° C.

In some embodiments, the curable adhesive film is a pressure sensitive adhesive including a first (meth)acrylate copolymer comprising from 0.1 weight percent to 12 weight percent of (meth)acrylic acid monomer units, based on the weight of the first (meth)acrylate copolymer; and a second (meth)acrylate copolymer comprising from 15 weight percent to 40 weight percent of (meth)acrylic acid monomer units, based on the weight of the second (meth)acrylate copolymer. The first (meth)acrylate copolymer and/or the second (meth)acrylate copolymer can comprise, as main monomer units, any of those described above. In some embodiments, the first (meth)acrylate copolymer and/or the second (meth)acrylate copolymer comprise, as main monomer units, linear or branched alkyl (meth)acrylate ester monomer units selected from the group consisting of 2-ethylhexyl (meth)acrylate, 2-propylheptyl (meth)acrylate, iso-octyl (meth)acrylate, and any combinations or mixtures thereof. In some embodiments, the first (meth)acrylate copolymer has a Tg of no greater than 0° C. and the second (meth)acrylate copolymer has a Tg of greater than 0° C. In some embodiments, the second (meth)acrylate copolymer has a Tg of no greater than 100° C., no greater than 80° C., no greater than 60° C., no greater than 50° C., no greater than 45° C., or even no greater than 40° C. In some embodiments, the first (meth)acrylate copolymer has a Tg of −70° C. to 0° C., −70° C. to −10° C., −60° C. to −10° C., −60° C. to −20° C., −60° C. to −30° C., −55° C. to −35° C., or −50° C. to −40° C. In some embodiments, the second (meth)acrylate copolymer has a Tg of 2° C. to 100° C., 2° C. to 80° C., 2° C. to 60° C., 2° C. to 50° C., 2° C. to 45° C., 5° C. to 45° C., 5° C. to 40° C., 5° C. to 35° C., or 10° C. to 30° C. In some embodiments, the curable adhesive film comprises from 65 to 99 weight percent, from 70 to 95 weight percent, from 75 to 95 weight percent, from 75 to 90 weight percent, or from 75 to 85 weight percent, of the first (meth)acrylate copolymer, and wherein the weight percentages are based on the total weight of the curable adhesive film composition. In some embodiments, the curable adhesive film in the article of the present disclosure comprises from 1 to 35 weight percent, from 1 to 30 weight percent, from 2 to 25 weight percent, from 3 to 25 weight percent, from 3 to 20 weight percent, from 4 to 20 weight percent, or even from 4 to 15 weight percent, of the second (meth)acrylate copolymer, and wherein the weight percentages are based on the total weight of the curable adhesive film composition. In some embodiments, these pressure sensitive adhesive compositions are described in U.S. Pat. Appl. Pub. No. 2021/0102099 (Unverhau et al.).

The polymer in the film of a polymer can be prepared by any suitable polymerization method. Suitable polymerization methods include, but are not limited to, photopolymerization, thermal polymerization, or ionizing radiation polymerization. These methods can be carried out in solution, emulsion, or bulk without solvent. Bulk polymerization methods are described in U.S. Pat. No. 5,804,610 (Hamer et al.). Optionally, photopolymerizable monomers may be partially polymerized to a viscosity of from 1000 cps to 40,000 cps to facilitate coating. Alternatively, partial polymerization can be effected by heat. If desired, viscosity can also be adjusted by mixing monomers with a thixotropic agent such as fumed silica.

Photopolymerization can take place in an inert atmosphere such as under a blanket of nitrogen or argon gas. Alternatively, an inert environment can be achieved by temporarily covering the photopolymerizable coating with a plastic film transparent to ultraviolet radiation and irradiating the coating through the film. If the polymerizable coating is not covered during photopolymerization, the permissible oxygen content of the inert atmosphere can be increased by mixing into the photopolymerizable composition an oxidizable tin compound such as disclosed in U.S. Pat. No. 4,303,485 (Levens), which can enable relatively thicker coatings to be polymerized in air.

The curable adhesive film useful in the article of the present disclosure includes unsaturated free-radically polymerizable groups, which may be bonded to the polymer (i.e., a reactive polymer comprising unsaturated free-radically polymerizable groups) or in a species other than the polymer. Unsaturated free-radically polymerizable groups include ethylenically unsaturated groups (e.g., vinyl-containing groups such as (meth)acrylate groups). In some embodiments, the unsaturated free-radically polymerizable groups are part of a crosslinker (i.e., crosslinkable species) distinct from the polymer making up the polymer film. Such crosslinkers include two or more or three or more unsaturated free-radically polymerizable groups. In some embodiments, the crosslinker is a crosslinking monomer. In some embodiments, the crosslinker is an oligomer.

Examples of suitable crosslinkers include trimethylolpropane triacrylate (TMPTA), ethoxy trimethylolpropane triacrylate, propoxy glycerol triacrylate, pentaerythritol triacrylate, bistrimethylolpropane tetraacrylate, pentaerythritol tetraacrylate, ethoxy pentaerythritol tetraacrylate, trimethylolpropane trimethacrylate, ethoxy pentaerythritol triacrylate, ditrimethylolpropane tetraacrylate, ethylene glycol diacrylate, diethylene glycol diacrylate, glycerol diacrylate, glycerol triacrylate, ethylene glycol dimethacrylate, 1,3-propanediol dimethacrylate, 1,2,4-butanetriol trimethacrylate, hexane diol diacrylate, tetraethylene glycol diacrylate, neopentyl glycol diacrylate, and combinations thereof. Further examples of crosslinkers include other multifunctional polyol esters. For example, acrylic acid or methacrylic acid esters of a variety of polyols in which at least two hydroxy groups are esterified can be used as crosslinkers.

The curable adhesive film useful in the article of the present disclosure additionally comprises a transition metal cation. Examples of suitable transition metal cations include molybdenum, titanium, vanadium, chromium, manganese, iron, cobalt, nickel, copper, or zinc. In some embodiments, the transition metal cation is a copper cation, such as Cu(II), such as may be found in copper(II) acetate monohydrate and copper (II) naphthenate. In some embodiments, the transition metal cation is an iron cation, such as Fe(II) or Fe(III), such as may be found in Black 11 (Fe₃O₄ or FeO·Fe₂O₃), Red 102 (Fe₂O₃), or Yellow 42 (Fe₂O₃·H₂O).

Useful transition metal complexes are described in U.S. Pat. No. 11,370,940 (Townsend et al.), and have the general formula: [MLₚ]ⁿ⁺A⁻, wherein M represents a transition metal capable of participating in a redox cycle with an oxidizing agent and a reducing agent. Useful transition metals, M, may include the catalytically active valent states of Cu, Fe, Ru, Cr, Mo, Pd, Ni, Pt, Mn, Rh, Re, Co, V, Au, Nb, and Ag. In some embodiments, the transition metal cation is a low valent transition metal including Cu(II), Fe(II), Ru(II), and Co(II). Other valent states of these metals may be used, and the active low valent state may be generated in situ.

In complexes of the formula [MLₚ]ⁿ⁺A⁻, L represents a ligand. The ligand, L, may be used to solubilize the transition metal salts in a suitable solvent and adjust the redox potential of the transition metal for appropriate reactivity and selectivity. The ligands can direct the transition metal complex to undergo a desired one-electron transfer process, rather than a two-electron process such as oxidative addition/reductive elimination. The ligands may further enhance the stability of the complexes in the presence of different monomers and solvents or at different temperatures. Acidic monomers and monomers that strongly complex transition metals may still be efficiently polymerized by appropriate selection of ligands. Useful ligands include those having one or more nitrogen, oxygen, phosphorus, and/or sulfur atoms which can coordinate to the transition metal through a sigma-bond, ligands containing two or more carbon atoms which can coordinate to the transition metal through a pi-bond, etc.

Such ligands may be monodentate or polydentate compounds, in some embodiments, containing up to about carbon atoms and up to 10 heteroatoms selected from aluminum, boron, nitrogen, sulfur, non-peroxidic oxygen, phosphorus, arsenic, selenium, antimony, and tellurium, where upon addition to the metal atom, following loss of zero, one, or two hydrogens, the polydentate compounds can form with the metal, Mⁿ⁺, a 4-, 5-, or 6-membered saturated or unsaturated ring. Examples of suitable monodentate ligands are carbon monoxide; alcohols such as ethanol, butanol, and phenol; pyridine, nitrosonium (i.e., NO); compounds of Group 15 elements such as ammonia, phosphine, trimethylamine, trimethylphosphine, tributylphosphine, triphenylamine, triphenylphosphine, triphenylarsine, or tributyl phosphite; nitriles such as acetonitrile or benzonitrile; isonitriles such as phenylisonitrile or butylisonitrile; carbene groups such as ethoxymethylcarbene or dithiomethoxycarbene; alkylidenes such as methylidene or ethylidene.

Examples of suitable polydentate compounds include dipyridyl, 1,2-bis(diphenyl-phosphino)ethane; 1,2-bis(diphenylarsino)ethane, bis(diphenylphosphino)methane, polyamines (e.g., ethylenediamine, propylenediamine, tetramethylethylenediamine, hexamethyl tris-aminoethylamine, diethylenetriamine, 1,3-diisocyanopropane, and hydridotripyrazolylborate), hydroxycarboxylic acids (e.g., glycolic acid, lactic acid, and salicylic acid), polyhydric phenols such as catechol and 2,2′-dihydroxybiphenyl, hydroxyamines (e.g., ethanolamine, propanolamine, and 2-aminophenol); dithiocarbamates such as diethyldithiocarbamate and dibenzyldithiocarbamate, xanthates such as ethyl xanthate and phenyl xanthate, dithiolenes such as bis(perfluoromethyl)-1,2-dithiolene, aminocarboxylic acids (e.g., alanine, glycine, and o-aminobenzoic acid); dicarboxylic diamines as oxalamide and biuret, diketones such as 2,4-pentanedione, hydroxyketones such as 2-hydroxyacetophenone, α-hydroxyoximes such as salicylaldoxime, ketoximes such as benzil oxime, 1,10-phenanthroline, porphyrins, cryptands and crown ethers such as 18-crown-6 ether, and glyoximes such as dimethylglyoxime.

Other suitable ligands that can coordinate to the transition metal through a sigma bond are the inorganic groups (e.g., F⁻, OH⁻, Cl⁻, Br⁻, I⁻, and hydride) and organic groups (e.g., CN⁻, SCN⁻, acetoxy, formyloxy, and benzoyloxy). The ligand can also be a unit of a polymer, for example, the amino group in poly(ethylenimine), the phosphino group in poly(4-vinylphenyldiphenylphosphine), the carboxylic acid group in poly(acrylic acid), and the isonitrile group in poly(4-vinylphenylisonitrile).

Useful ligands containing two or more carbon atoms that can coordinate to the transition metal through a pi-bond are provided by any monomeric or polymeric compound having an accessible unsaturated group, e.g., an ethylenic group, acetylenic group, or aromatic group which has accessible pi-electrons regardless of the total molecular weight of the compound. Examples of pi-bond ligands include the linear and cyclic ethylenic and acetylenic compounds having less than 100 carbon atoms (when monomeric), in some embodiments, having less than 60 carbon atoms, and from zero to 10 heteroatoms selected from nitrogen, sulfur, non-peroxidic oxygen, phosphorous, arsenic, selenium, boron, aluminum, antimony, tellurium, silicon, germanium, and tin. Specific examples of such pi-bond ligands include ethylene, acetylene, propylene, methylacetylene, α-butene, 2-butene, diacetylene, butadiene, 1,2-dimethylacetylene, cyclobutene, pentene, cyclopentene, hexene, cyclohexene, 1,3-cyclohexadiene, cyclopentadiene, 1,4-cyclohexadiene, cycloheptene, 1-octene, 4-octene, 3,4-dimethyl-3-hexene, 1-decene; 13-allyl, 11-pentenyl, norbornadiene, η⁵-cyclohexadienyl, cycloheptatriene, and cyclooctatetraene.

Further suitable pi-bond ligands include substituted and unsubstituted carbocyclic and heterocyclic aromatic ligands having up to 25 rings and up to 100 carbon atoms and up to 10 hetero atoms selected from nitrogen, sulfur, non-peroxidic oxygen, phosphorus, arsenic, selenium, boron, aluminum, antimony, tellurium, silicon, germanium, and tin. Specific examples of such pi-bond ligands include η⁵-cyclopentadienyl, benzene, mesitylene, toluene, xylene, tetramethylbenzene, hexamethylbenzene, fluorene, naphthalene, anthracene, chrysene, pyrene, 17-cycloheptatrienyl, triphenylmethane, paracyclophane, 1,4-diphenylbutane, η⁵-pyrrolo, 95-thiophene, 15-furan, pyridine, y-picoline, quinaldine, benzopyran, thiochrome, benzoxazine, indole, acridine, carbazole, triphenylene, silabenzene, arsabenzene, stibabenzene, 2,4,6-triphenylphosphabenzene, η⁵-selenophene, dibenzostannepine, η⁵-tellurophene, phenothiazine, selenanthrene, phenoxaphosphine, phenarsazine, phenatellurazine, η⁵-methylcyclopentadienyl, η⁵-pentamethylcyclopentadienyl, and 1-phenylborabenzene.

In some embodiments, ligands include unsubstituted and substituted pyridines and bipyridines, tertiary amines, including polydentate amines such as N,N,N′,N′-tetramethylethylenediamine and tris(N,N-dimethylamino-ethyl)amine, acetonitrile, phosphites (e.g., (CH₃O)₃P), 1,10-phenanthroline, porphyrin, cryptands and crown ethers (e.g., 18-crown-6 ether). In some embodiments, the ligand is a polydentate amine, bipyridine, or a phosphite. Ligands and ligand-metal complexes useful in the initiator systems of the present disclosure are described in Matyjaszewski and Xia, Chemical Reviews, 2001, vol. 101, pp. 2921-2990.

In complexes of the formula [MLₚ]ⁿ⁺A⁻, A⁻ represents an anion. Examples of useful anions, A⁻, include halide (e.g., chloride, bromide, fluoride), alkoxy groups having from 1 to 6 carbon atoms (i.e., C₁-C₆ alkoxy), nitrate, sulfate, phosphate, biphosphate, hexafluorophosphate, triflate, methanesulfonate, arenesulfonate, cyanide, alkanecarboxylates (e.g., acetate), and arenecarboxylates (e.g., benzenecarboxylate). In complexes of the formula [MLₚ]ⁿ⁺A⁻, n represents the formal charge on the transition metal having a whole number value of 1 to 7, in some embodiments, 1 to 3, and p is the number of ligands on the transition metal having a number value of 1 to 9, in some embodiments, 1 or 2.

The curable adhesive film useful in the article of the present disclosure additionally comprises an oxidizing agent. Any suitable oxidizing agent may be used. Suitable oxidizing agents include organic peroxides and hydroperoxides, inorganic peroxides, and persulfates.

Suitable organic peroxides include hydroperoxides, di-peroxides, ketone peroxides, diacyl peroxides, dialkyl peroxides, peroxyketals, peroxyesters, and peroxydicarbonates. Suitable organic hydroperoxides include those represented by formula R—O—O—H with R being linear alkyl (e.g., C₁-C₂₀ linear alkyls), branched alkyl (e.g., C₃-C₂₀ branched alkyls), cycloalkyl (e.g., C₆-C₁₂ cycloalkyls), alkaryl (e.g., C₇-C₂₀ alkaryls), aralkyls (e.g., C₇-C₂o aralkyls), and aryls (e.g., C₆-C₁₂ aryls). Examples of suitable organic hydroperoxides include t-butyl hydroperoxide, t-amyl hydroperoxide, p-diisopropylbenzene hydroperoxide, cumene hydroperoxide, pinane hydroperoxide, p-methane hydroperoxide, and 1,1,3,3-tetramethylbutyl hydroperoxide. Suitable organic peroxides include di-peroxides represented by formula R¹—O—O—R²—O—O—R³, with R¹ and R³ being independently selected from H, linear alkyls (e.g., C₁-C₆ linear alkyls), branched alkyls (e.g., C₁-C₆ branched alkyls), cycloalkyls (e.g., C₅-C₁₀ cycloalkyls), alkaryls (e.g., C₇-C₁₂ alkaryls), aralkyls (e.g., C₇-C₂₀ aralkyls), or aryls (e.g., C₆-C₁₀ aryls), and R² being selected from linear or branched alkylene (e.g., C₁-C₆ linear or branched alkylene). Suitable ketone peroxides include methyl ethyl ketone peroxide, methyl isobutyl ketone peroxide, methyl cyclohexanone peroxide, and cyclohexanone peroxide. Suitable peroxyesters include alpha-cumylperoxyneodecanoate, t-butyl peroxypivarate, t-butyl peroxyneodecanoate, 2,2,4-trimethylpentylperoxy-2-ethyl hexanoate, t-amylperoxy-2-ethyl hexanoate, t-butylperoxy-2-ethyl hexanoate, di-t-butylperoxy isophthalate, di-t-butyl peroxy hexahydroterephthalate, t-butylperoxy-3,3,5-trimethylhexanoate, t-butylperoxy acetate, t-butylperoxy benzoate, and t-butylperoxymaleic acid. Suitable peroxydicarbonates include di-3-methoxy peroxidicarbonate, di-2-ethylhexyl peroxy-dicarbonate, bis(4-t-butylcyclohexyl)peroxidicarbonate, diisopropyl-1-peroxydicarbonate, di-n-propyl peroxidicarbonate, di-2-ethoxyethyl-peroxidicarbonate, and diallyl peroxidicarbonate. Suitable diacyl peroxides include acetyl peroxide, benzoyl peroxide, decanoyl peroxide, 3,3,5-trimethylhexanoyl peroxide, 2,4-dichlorobenzoyl peroxide, and lauroylperoxide. Suitable dialkyl peroxides include di-t-butyl peroxide, dicumylperoxide, t-butylcumyl peroxide, 2,5-dimethyl-2,5-di(t-butylperpoxy)hexane, 1,3-bis(t-butylperoxyisopropyl)benzene, and 2,5-dimethyl-2,5-di(t-butylperoxy)-3-hexane. Suitable peroxyketals include 1,1-bis(t-butylperoxy)-3,3,5-trimethylcyclohexane, 1,1-bis(t-butylperoxy)cyclohexane, 2,2-bis(t-butylperoxy)butane, 2,2-bis(t-butylperoxy)octane, and 4,4-bis(t-butylperoxy)valeric acid-n-butylester. Other suitable organic peroxides may additionally include t-butyl peroxy ethylhexyl carbonate, t-butyl peroxy trimethylhexanoate, t-butyl peroxy ethylhexanoate, t-amyl peroxy ethylhexanoate, t-octyl peroxy ethylhexanoate, t-amyl peroxy ethylhexyl carbonate, t-butyl peroxy isopropyl carbonate, t-butyl peroxyneodecanoate, and t-butyl peroxyisobutyrate.

In some embodiments, the curable adhesive film additionally includes a redox accelerator, such as a quaternary ammonium salt, amine hydrochloride, sodium chloride, or a phosphonium salt. Suitable quaternary ammonium salts may be represented by formula (R⁷)₄N+ X−, wherein each R⁷ is independently alkyl, aryl, or a combination thereof, any of which may be substituted or unsubstituted, and X is Cl, Br, F, SbF, BF, or PF. Examples of suitable quaternary ammonium salts include dimethyl benzyl aniline chloride (DMBAC) and benzyltriethylammonium chloride. Suitable phosphonium salts may be represented by formula (R⁸)₄P+X−, wherein each R⁸ is independently alkyl, aryl, or a ^{combination} thereof, any of which may be substituted or unsubstituted, and X is Cl, Br, F, SbF, BF, or PF. In some embodiments, each R⁸ is independently phenyl or C₁-C₅ alkyl. Examples of suitable phosphonium salts include allyltriphenylphosphonium bromide (ATPB), 2-(ethoxycarbonyl)ethyl-triphenylphosphonium bromide, 1-ethoxycarbonylethyl triphenylphosphonium bromide, 4-ethoxycarbonylbutyl triphenylphosphonium bromide, carbethoxymethyl triphenylphosphonium bromide, and methyltriphenylphosphonium bromide. Various combinations of redox accelerators may be used if desired. In some embodiments, the redox accelerator is used in an amount of at least 0.25 weight percent, and typically up to 4 weight percent, based on the total weight of the curable adhesive film.

While this disclosure is not to be bound by any theory or proposed mechanism, it is believed that the oxidizing agent in the curable adhesive film oxidizes the transition metal cation (e.g., Cu(I) to Cu(II)) forming radicals that initiate crosslinking of the crosslinkable species (typically catalytically) thereby forming a crosslinked network. It is believed that the redox accelerator, when present, serves as a reducing agent of the initially provided Cu(II) cation to Cu(I).

The curable adhesive film useful in the article of the present disclosure is typically a room temperature solid. As described above, each of the components of the curable adhesive film, including the polymer, the optional crosslinker, the transition metal cation, the oxidizing agent, and optionally the redox accelerator (e.g., a quaternary ammonium salt) can be combined in the presence of oxygen and coated onto a web. The curable adhesive film may be made using conventional techniques such as solution coating onto a web. In some embodiments, including the embodiments illustrated in FIGS. 4 to 6, the curable adhesive film is made from an adhesive film that is hot melt processable and is made in a hot melt process. Hot melt processing, such as hot melt blending or hot melt extrusion, may be accomplished by any suitable means, including those disclosed in U.S. Pat. Appl. Pub. No. 2013/0184394 (Satrijo et al.). In some embodiments, adhesive films that may be hot melt processable comprise a blend of a reactive polymer comprising unsaturated free-radically polymerizable groups, which are typically pendant groups, and a transition metal cation. In some embodiments, adhesive films that may be hot melt processed comprise a blend of a film-forming polymer or oligomer, a reactive species comprising unsaturated free-radically polymerizable groups, and a transition metal cation. In some of these embodiments, the adhesive film further includes a redox accelerator (e.g., a quaternary ammonium salt). The adhesive film made by hot melt processing can then be applied directly adjacent an activator on a substrate or release liner to provide the curable adhesive film once the oxidizing agent migrates into the adhesive film.

The curable or cured adhesive film in the article of the present disclosure may be of any suitable thickness. In some embodiments, the thickness is at least 20 micrometers, at least 25 micrometers, at least 50 micrometers, at least 100 micrometers, at least 200 micrometers, at least 250 micrometers, at least 300 micrometers, or at least 350 micrometers. In some embodiments, the thickness is not more than 2000 micrometers, not more than 1000 micrometers, or not more than 500 micrometers.

In some embodiments, the curable adhesive film is a first layer of a multilayer curable adhesive film, wherein the multilayer curable adhesive film further comprises a support layer. In some embodiments, the support layer is a foam support layer, in some embodiments, a curable foam support layer. In some embodiments, the curable foam support layer includes a base polymer. The base polymer may be the same or different than the film-forming polymer useful for the film of the polymer in the curable adhesive film and may be any of those described above for the curable adhesive film. The base polymer of the curable foam support layer may be the same as the polymer in the curable adhesive film, which may or may not include unsaturated free-radically polymerizable groups. The base polymer can also be made and processed by any of the processes described above for the curable adhesive film.

In some embodiments, the base polymer of the support layer, which may be a foam support layer or a curable foam support layer, is a silicone polymer. Acrylate and silicone foams are useful due to their ultraviolet light stability, conformability, and ability to distribute stress. Suitable silicone polymers can include an MQ resin containing a resinous core and nonresinous polyorganosiloxane group terminated with a silicon-bonded hydroxyl group, a treated MQ resin, and a polydiorganosiloxane terminated with a condensation reactable group. Such compositions may be used for structural glazing applications, as described in U.S. Pat. No. 8,298,367 (Beger et al.).

In some embodiments, the support layer, which in some embodiments, is a foam support layer or a curable foam support layer, includes a crosslinker mixed therein. If the base polymer of the curable foam support layer does not include unsaturated free-radically polymerizable groups, in some embodiments, such groups may be provided by a distinct species within the curable foam support layer, or they may be provided by a species that migrates into the curable foam support layer. Examples of suitable crosslinkers include those described above for the curable adhesive films.

Thus, in some embodiments, the curable foam support layer includes a base polymer that is receptive to receiving a crosslinker that is migratable into the curable foam support layer. In some embodiments, the crosslinker migrates from the curable adhesive film into the curable foam support layer. Thus, in these embodiments, the crosslinker of the curable foam support layer is the same as the species comprising unsaturated free-radically polymerizable groups of the curable adhesive film. The same crosslinker may also be separately loaded into the curable adhesive film and the curable foam support layer. The crosslinker of the curable foam support layer may, in other embodiments, be different than the species comprising unsaturated free-radically polymerizable groups of the curable adhesive film.

The crosslinker that is included within the curable foam support layer and/or migrates into the curable foam support layer, and that is included within the curable adhesive film, is activated when oxygen is excluded from the curable adhesive film or multilayer curable adhesive film to start the redox cycle, thereby initiating crosslinking. This crosslinking of the crosslinker results in curing of both the curable adhesive film and the curable foam support layer. It is believed that an interpenetrating crosslinked network is formed in the bulk of the adhesive layers wherein the first network is that formed from the crosslinker(s) and the second network is that from the film-forming polymer(s). This crosslinked network is formed across the boundary between the various layers of the multilayer curable adhesive film (e.g., across the boundary between a cured adhesive film and a cured foam support layer), which is evidenced by cohesive failure, for example, splitting the foam support layer.

In some embodiments, the curable foam support layer includes a transition metal cation as described for the curable adhesive film. In some embodiments, the curable foam support layer also includes a redox accelerator as described for the curable adhesive film.

The foam support layer, in some embodiments, the curable foam support layer of the multilayer curable adhesive film useful in some embodiments of the present disclosure may be a closed cell foam, an open cell foam, a syntactic foam, a non-syntactic foam, or a combination thereof. Such foams can be made using chemical foaming agents, physical foaming agents, and mechanical foaming processes, for example. In some embodiments, the curable foam support layer includes a foaming agent and the same components as the curable adhesive film. In some embodiments, the foaming agent comprises at least one of expandable microspheres, hollow glass bubbles, or gas (e.g., nitrogen) bubbles, which are optionally surfactant stabilized. For example, a foam can be made from froth formed from physical agitation and stabilized with surfactant, such as a silicone or a fluorochemical known to be useful for foaming organic liquids that have low surface tension (e.g., those described in U.S. Pat. No. 4,415,615 (Esmay et al.)).

In some embodiments, the foam is a syntactic foam containing hollow microspheres, for example, hollow ceramic (e.g., glass) microspheres. Useful hollow glass microspheres include those having a density of less than 0.4 gram per milliliter (g/mL) and having a diameter of from 5 to 200 micrometers.

The microspheres may be clear, coated, stained, or a combination thereof. Useful hollow glass microspheres include those available under the trade designation “3 M GLAS S BUBBLES K37” from 3M Co., St Paul, MN). The microspheres typically comprise from 5 to 65 volume percent of the foam composition. Examples of useful acrylic foams thus made are disclosed in U.S. Pat. No. 4,415,615 (Esmay et al.) and U.S. Pat. No. 6,103,152 (Gehlsen et al.).

In some embodiments, foams are formed by blending expanded polymeric microspheres into a polymerizable composition. In some embodiments, foams are formed by blending expandable polymeric microspheres into a composition and expanding the microspheres. An expandable polymeric microsphere includes a polymer shell and a core material in the form of a gas, liquid, or combination thereof. Upon heating to a temperature at or below the melt or flow temperature of the polymeric shell, the polymer shell expands to form the microsphere. Suitable core materials include propane, butane, pentane, isobutane, neopentane, isopentane, and combinations thereof. The thermoplastic resin used for the polymer microsphere shell can influence the mechanical properties of the foam, and the properties of the foam may be adjusted by the choice of microsphere, or by using mixtures of different types of microspheres. Examples of commercially available expandable microspheres include those available under the trade designation “EXPANCEL” (e.g., under the trade designation “EXPANCEL 551 DE”) from Akzo Nobel Pulp, Duluth, GA, and Performance Chemicals AB, Sundsvall, Sweden. Methods of making foams containing expandable polymeric microspheres and particulars of these microspheres are described in U.S. Pat. No. 6,103,152 (Gehlsen et al.).

Foams may also be prepared by forming gas voids in a composition using a variety of mechanisms including, for example, mechanical mechanisms, chemical mechanisms, and combinations thereof. Useful mechanical foaming mechanisms include, for example, agitating (for example, shaking, stirring, or whipping the composition, and combinations thereof), injecting gas into the composition (for example, inserting a nozzle beneath the surface of the composition and blowing gas into the composition), and combinations thereof. Methods of making the foams with voids formed via a foaming agent are described in U.S. Pat. No. 6,586,483 (Kolb et al.).

In some embodiments, the curable support foam layers have a foam density of from 320 kilograms per cubic meter (kg/m³) to 1041 kg/m³, from 400 kg/m³ to 880 kg/m³, or from 561 kg/m³ to 800 kg/m³.

In some embodiments, the curable foam support layer further includes a polymer modulus modifier to provide a desirable modulus. In some embodiments, the polymer modulus modifier comprises a polymer having a Tg of no greater than 100° C., no greater than 90° C., no greater than 80° C., no greater than 70° C., no greater than 60° C., no greater than 50° C., or no greater than 40° C. In some embodiments, the polymer modulus modifier comprises a polyvinyl acetal resin, particularly polyvinyl butyral (PVB). In some embodiments, the polymer modulus modifier comprises a high acid polymer. It is believed the polymer modulus modifier increases the modulus of the foam and/or toughens the system against an applied force.

In some embodiments, the polyvinyl acetal resin includes polymerized units having the formula:

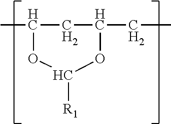

where R₁ is hydrogen or an alkyl group having 1 to 7 carbon atoms (C₁-C₇). Polyvinyl acetal resins may be obtained, for example, by reacting polyvinyl alcohol with aldehyde, as known in the art. Polyvinyl alcohol resins are not limited by the production method. For example, those produced by saponifying polyvinyl acetate, for example, with alkali, acid, or ammonia water can be used. Polyvinyl alcohol resins may be either completely saponified or partially saponified. In some embodiments, the polyvinyl alcohol resin has a saponification degree of 80 mol % or more. Polyvinyl alcohol resins may be used singly or in combination of two or more.

Examples of suitable aldehydes used in the production of the polyvinyl acetal resin include formaldehyde (including paraformaldehyde), acetaldehyde (including para-acetaldehyde), propionaldehyde, butyraldehyde, n-octylaldehyde, amylaldehyde, hexylaldehyde, heptylaldehyde, 2-ethylhexylaldehyde, cyclohexylaldehyde, furfural, glyoxal, glutaraldehyde, benzaldehyde, 2-methylbenzaldehyde, 3-methylbenzaldehyde, 4-methylbenzaldehyde, p-hydroxybenzaldehyde, m-hydroxybenzaldehyde, phenylacetaldehyde, and beta-phenylpropionaldehyde. These aldehydes may be used singly or in combination of two or more.

In some embodiments, the alkyl residue of aldehyde includes 1 to 7 carbon atoms. In other embodiments, the alkyl reside of the aldhehyde includes 3 to 7 carbon atoms such as in the case of butylaldehyde, hexylaldehyde, and n-octylaldehyde. Of these butyraldehyde, also known as butanal, is most commonly utilized. Polyvinyl butyral (“PVB”) resin is commercially available from Kuraray under the trade designation MOWITAL and Solutia under the trade designation BUTVAR.

In some embodiments, the polyvinyl acetal (e.g., butyral) resin has a Tg ranging from 60° C. to 80° C., or 60° C. to 75° C. In some embodiments, the Tg of the polyvinyl acetal (e.g., butyral) resin is at least 65° C., or at least 70° C. When other aldehydes, such as n-octyl aldehyde, are used in the preparation of the polyvinyl acetal resin, the Tg may be less than 65° C., or even less than 60° C. The Tg of the polyvinyl acetal resin is typically at least 35° C., at least 40° C., or at least 45° C. When the polyvinyl acetal resin has a Tg of less than 60° C., higher concentrations of high Tg monomers may be employed in comparison to those utilizing polyvinyl butyral resin. When other aldehydes, such as acetaldehyde, are used in the preparation of the polyvinyl acetal resin, the Tg may be greater than 75° C., or greater than 80° C. When the polyvinyl acetal resin has a Tg of greater than 70° C., higher concentrations of low Tg monomers may be employed in comparison to those utilizing polyvinyl acetal butyral resin.

The polyvinyl acetal (e.g., PVB) resin typically has a weight average molecular weight (Mw) of at least 10,000 g/mole, 15,000 g/mole or 30,000; and no greater than 100,000 g/mole, 80,000 g/mole or 60,000 g/mole.

The polyacetal resin is typically a random copolymer; however, block copolymers and tapered block copolymers may provide similar benefits as random copolymers. Examples of polyvinyl acetal resins are described in U.S. Pat. Appl. Pub. No. 2021/0102100 (Xia et al.).

In some embodiments, if used, the polyvinyl acetal resin is used in an amount of at least 5 weight percent, at least 7 weight percent, or at least 10 weight percent, based on total weight of the curable foam support layer composition. If used, the polyvinyl acetal resin is used in an amount of up to 25 weight percent, up to 20 weight percent, or up to 15 weight percent, based on total weight of the curable foam support layer composition.

In some embodiments, the polymer modulus modifier comprises a high acid polymer. High acid in this context means there is an acrylate polymer that has higher amounts of acrylic acid in it than in a conventional pressure sensitive adhesive, such as 90:10 isooctyl acrylate:acrylic acid. This makes the polymer “stiffer” (i.e., with a higher modulus).

In some embodiments, the high acid polymer is the second (meth)acrylate copolymer comprising from 15 weight percent to 40 weight percent of (meth)acrylic acid monomer units, based on the weight of the second (meth)acrylate copolymer, described above for some embodiments of the curable adhesive film. In some embodiments, the high acid polymer has a Tg of 2° C. to 100° C., 2° C. to 80° C., 2° C. to 60° C., 2° C. to 50° C., 2° C. to 45° C., 5° C. to 45° C., 5° C. to 40° C., 5° C. to 35° C., or 10° C. to 30° C. The high acid polymer is believed to provide outstanding mechanical properties, due in particular to the relatively high concentration of (meth)acrylic acid monomer units.

In some embodiments, if used, the high acid polymer is used in an amount of at least 1 weight percent, at least 2 weight percent, at least 3 weight percent, or at least 4 weight percent, based on the total weight of the curable foam support layer. If used, the high acid polymer is used in an amount of up to 35 weight percent, up to 30 weight percent, up to 25 weight percent, up to 20 weight percent, or up to 15 weight percent, based on the total weight of the curable foam support layer.

The curable foam support layer may contain one or more optional additives. Such additives can include fillers, antioxidants, viscosity modifiers, pigments (inorganic or organic), tackifying resins, fibers, flame retardants, antistatic and slip agents, thermally conductive particles, electrically conductive particles, continuous microfibers, filaments, and mixtures thereof. Various additives may be used in amounts typical for adhesive tapes.

Besides the hollow microspheres described above, useful fillers include glass beads, metal oxide particles, silica particles (e.g., fumed silica), carbonates, metal oxides, silicates (e.g., talc, asbestos, clays, mica), sulfates (e.g., barium sulfate), metals in powder form (e.g., aluminum, zinc and iron), silicon dioxide, and aluminum trihydrate. In some embodiments, the solid or hollow filler particles comprise a polymer, glass, ceramic, or metal oxide material. Combinations of two or more fillers may be used if desired. In some embodiments, the filler comprises fumed silica.

Examples of useful organic pigments include halogenated copper phthalocyanines, aniline blacks, anthraquinone blacks, benzimidazolones, azo condensations, arylamides, diarylides, disazo condensations, isoindolinones, isoindolines, quinophthalones, anthrapyrimidines, flavanthrones, pyrazolone oranges, perinone oranges, beta-naphthols, BON arylamides, quinacridones, perylenes, anthraquinones, dibromanthrones, pyranthrones, diketopyrrolo-pyrrole pigments (DPP), dioxazine violets, copper and copper-free phthalocyanines, and indanthrones. Examples of useful inorganic pigments include titanium dioxide, zinc oxide, zinc sulphide, lithopone, antimony oxide, barium sulfate, carbon black, graphite, black iron oxide, black micaceous iron oxide, brown iron oxides, metal complex browns, lead chromate, cadmium yellow, yellow oxides, bismuth vanadate, lead chromate, lead molybdate, cadmium red, red iron oxide, Prussian blue, ultramarine, cobalt blue, chrome green (Brunswick green), chromium oxide, hydrated chromium oxide, organic metal complexes, and laked dye pigments.

The polymer used to make the curable foam support layer may be initially coated onto and polymerized against a flexible backing sheet (for example, a release liner) that has a low-adhesion surface from which the polymerized layer is readily removable. If the opposite face of the backing sheet also has a low adhesion surface, the backing sheet with its polymerized layer may be wound up in roll form for storage prior to assembly of the finished adhesive article.

The curable or cured foam support layers in the article of the present disclosure may be of any suitable thickness. In some embodiments, the thickness is at least 20 micrometers, at least 25 micrometers, at least 50 micrometers, at least 100 micrometers, at least 200 micrometers, at least 250 micrometers, at least 300 micrometers, or at least 350 micrometers. In some embodiments, the thickness is not more than 2000 micrometers, not more than 1000 micrometers, or not more than 500 micrometers.

Multilayer curable adhesive films in the articles of the present disclosure may include two or more curable adhesive films having components that are the same or different (i.e., they are independently selected). Multilayer curable adhesive films may include two or more curable foam support layers having components that are the same or different (i.e., they are independently selected). In some embodiments, the multilayer curable adhesive film further comprises a second curable adhesive layer comprising a second film of a second independently selected polymer, second independently selected unsaturated free-radically polymerizable groups, which may be bonded to the second independently selected polymer or in a second species other than the second independently selected polymer, and a second independently selected transition metal cation. In some embodiments, the second curable adhesive layer is adjacent to a surface of the foam support layer opposite the first layer.

In some embodiments, including the embodiments illustrated in FIGS. 1 to 6, the oxidizing agent is incorporated into the curable adhesive film using an activator, from which the oxidizing agent migrates into the adhesive film. In some embodiments, the activator is liquid at normal temperature and pressure. In some embodiments, the activator comprises a liquid carrier. In some embodiments, the liquid carrier is a solvent. In some embodiments, the activator composition comprises 75 weight percent to 99 weight percent, or 93 weight percent to 98 weight percent, of the solvent, wherein the weight percentages are all based on the total weight of the activator composition. In some embodiments, the activator includes a plasticizer. In some embodiments, the plasticizer is of the following formula: (R—X—)ₙZ, wherein: each R may be hydrogen, C₁-C₁₄ alkyl, aryl, alkaryl, or aralkyl, each optionally interrupted by oxygen, nitrogen, carbonyl, carboxyl, or carbamide; each X may be oxygen, nitrogen, carbonyl, carboxyl, or carbamide; Z may be a hydrogen, C₁-C₁₄ alkyl, aryl, alkaryl, aralkyl, C₁-C₁₄ alkylene, arylene, alkarylene, aralkylene, each optionally interrupted by oxygen, nitrogen, carbonyl, carboxyl, or carbamide; and n is an integer of 1 to 5. In some embodiments, n is an integer of 1 to 4. In some embodiments, the plasticizer comprises at least one of a benzoic acid ester, a myristic acid ester, a citric acid ester, an acetic acid ester, a succinic acid ester, a glutaric acid ester, an adipic acid ester, or a sebacic acid ester. In some embodiments, the plasticizer comprises at least one of a benzoic acid ester, a myristic acid ester, or a citric acid ester. A citric acid ester may have one, two, three, or four R groups.

In some embodiments, the activator further comprises a film-forming polymer. The film-forming polymer can be any of these described herein for the curable adhesive film. In some embodiments, the film-forming polymer is a reactive polymer comprising unsaturated free-radically polymerizable groups, as described herein for the curable adhesive film. In some embodiments, the film-forming polymer does not comprise unsaturated free-radically polymerizable groups, as described herein for the curable adhesive film. In some embodiments, the activator may include a reactive species comprising unsaturated free-radically polymerizable groups, as described herein for the curable adhesive film. These components may be the same or different from these components in the curable adhesive film.

In some embodiments, the film-forming polymer may include a rubber and/or a (meth)acrylic resin. In some embodiments, the (meth)acrylic resin is a (meth)acrylic polymer made from any of the monomers described above for the curable adhesive film and the curable foam support layer. In some embodiments, the (meth)acrylic polymer is any of those described above for the curable adhesive film and the curable foam support layer.

In some embodiments, the rubber comprises a block copolymer of a styrene and an alkene. In some embodiments, the rubber comprises a styrene-ethylene/butylene-styrene block copolymer grafted with maleic anhydride. In some embodiments, the rubber comprises at least one of a styrene-isoprene-styrene copolymer, styrene-butadiene-styrene copolymer, a styrene-ethylene-butylene-styrene copolymer.

When containing a film-forming polymer, the activator may be a liquid at normal temperature and pressure, for example, if the film-forming polymer is dissolved in a solvent. In other embodiments, the activator may be applied as a free-standing film, as described herein for the curable adhesive film.

In some embodiments, the oxidizing agent is present in the activator in an amount of at least 0.5 weight percent, at least 1 weight percent, at least 2 weight percent, or at least 4 weight percent, based on the total weight of the activator. In some embodiments, the oxidizing agent is present in the activator in an amount of up to 20 weight percent, up to 15 weight percent, up to 10 weight percent, or up to 5 weight percent, based on the total weight of the activator composition.

In some embodiments, the activator also includes a transition metal cation, which may be one or more of any of those described herein for the curable adhesive film. In some embodiments, the activator further includes a silane (e.g., epoxy silane). In some embodiments, the activator includes no tackifier, or no species comprising unsaturated free-radically polymerizable groups, or both no tackifier and no species comprising unsaturated free-radically polymerizable groups.

Articles of the present disclosure, including those illustrated in FIGS. 4, 5, and 6 may include two or more activator layers having components that are the same or different (i.e., they are independently selected). The activator layers may be of any suitable thickness. In some embodiments, thickness is at least 1 micrometer, at least 2 micrometers, at least 3 micrometers, at least 4 micrometers, or at least 5 micrometers. In some embodiments, thickness is not more than 20 micrometers, not more than 15 micrometers, or not more than 10 micrometers.

During use, the activator is typically applied to a substrate, optionally allowed to dry, and the curable adhesive film is applied to the activator-coated substrate. Activator layers may be cured or simply dried in articles which include two substrates bonded together using structural adhesive bonds generated from the curable adhesive film. In embodiments in which the activator includes unsaturated free-radically polymerizable groups, the activator layer may become cured once the oxygen-permeable liner is removed and replaced with a substrate to be bonded.

### SOME EMBODIMENTS OF THE PRESENT DISCLOSURE

In a first embodiment, the present disclosure provides an article comprising a curable adhesive film comprising a film of a polymer, unsaturated free-radically polymerizable groups, which may be bonded to the polymer or in a species other than the polymer, a transition metal cation, and an oxidizing agent and an oxygen-permeable liner on at least one side of the curable adhesive film. In a second embodiment, the present disclosure provides the article of the first embodiment, wherein the curable adhesive film further comprises a quaternary ammonium salt. In a third embodiment, the present disclosure provides the article of the first or second embodiment, wherein the curable adhesive film is stable at room temperature for at least two weeks.

In a fourth embodiment, the present disclosure provides the article of any one of the first to third embodiments, wherein the curable adhesive film is a first layer of a multilayer curable adhesive film, wherein the multilayer curable adhesive film further comprises a foam support layer. In a fifth embodiment, the present disclosure provides the article of the fourth embodiment, wherein the foam support layer is curable. In a sixth embodiment, the present disclosure provides the article of the fourth or fifth embodiment, wherein the foam support layer comprises at least one of a closed cell foam or a syntactic foam. In a seventh embodiment, the present disclosure provides the article of any one of the fourth to sixth embodiments, wherein the foam support layer comprises a base polymer which is the same as the polymer in the curable adhesive film. In an eighth embodiment, the present disclosure provides the article of any one of the fourth to seventh embodiments, wherein the foam support layer comprises a crosslinker within the foam support layer. In a ninth embodiment, the present disclosure provides the article of the eighth embodiment, wherein the crosslinker is different from the species comprising unsaturated free-radically polymerizable groups in the curable adhesive film. In a tenth embodiment, the present disclosure provides the article of the eighth embodiment, wherein the crosslinker is the species comprising unsaturated free-radically polymerizable groups in the curable adhesive film that migrates and/or has migrated (i.e., having migrated) into the curable support layer. In an eleventh embodiment, the present disclosure provides the article of any one of the fourth to eighth or tenth embodiments, wherein the foam support layer comprises a foaming agent and the same components as the curable adhesive film. In a twelfth embodiment, the present disclosure provides the article of the eleventh embodiment, wherein the foaming agent comprises at least one of expandable microspheres, hollow glass bubbles, or gas bubbles optionally stabilized with a surfactant. In a thirteenth embodiment, the present disclosure provides the article of any one of the fourth to twelfth embodiments, wherein the curable foam support layer further comprises a polymer modulus modifier. In a fourteenth embodiment, the present disclosure provides the article of the thirteenth embodiment, wherein the polymer modulus modifier comprises a polymer having a Tg of no greater than 100° C., no greater than 90° C., no greater than 80° C., no greater than 70° C., no greater than 60° C., no greater than 50° C., or no greater than 40° C. In a fifteenth embodiment, the present disclosure provides the article of the thirteenth or fourteenth embodiment, wherein the polymer modulus modifier comprises a polyvinyl acetal resin (e.g., polyvinyl butyral). In a sixteenth embodiment, the present disclosure provides the article of the thirteenth or fourteenth embodiment, wherein the polymer modulus modifier comprises a high acid polymer. In a seventeenth embodiment, the present disclosure provides the article of any one of the fourth to sixteenth embodiments, wherein the curable foam support layer further comprises a transition metal cation and a quaternary ammonium salt. In an eighteenth embodiment, the present disclosure provides the article of any one of the fourth to seventeenth embodiments, wherein the curable foam support layer is hot melt processable. In a nineteenth embodiment, the present disclosure provides the article of any one of the fourth to eighteenth embodiments, wherein the curable adhesive film is borne on a first major surface of the foam support layer. In a twentieth embodiment, the present disclosure provides the article of any one of the fourth to eighteenth embodiments, wherein the curable adhesive film is directly bound to (e.g., laminated to) a first major surface of the foam support layer.

In a twenty-first embodiment, the present disclosure provides the article of any one of the fourth to twentieth embodiments, wherein the multilayer curable adhesive film further comprises a second curable adhesive layer comprising a second film of a second independently selected polymer, second independently selected unsaturated free-radically polymerizable groups, which may be bonded to the second independently selected polymer or in a second species other than the second independently selected polymer, and a second independently selected transition metal cation. In a twenty-second embodiment, the present disclosure provides the article of the twenty-first embodiment, wherein the second curable adhesive layer is adjacent to a surface of the foam support layer opposite the first layer. In a twenty-third embodiment, the present disclosure provides the article of the twenty-second embodiment, wherein the first layer is borne on a first major surface of the foam support layer and the second curable adhesive layer is borne on a second major surface of the foam support layer. In a twenty-fourth embodiment, the present disclosure provides the article of the twenty-second embodiment, wherein the first layer is directly bound to a first major surface of the foam support layer and the second curable adhesive layer is directly bound to a second major surface of the foam support layer.

In a twenty-fifth embodiment, the present disclosure provides the article of any one of the first to twenty-fourth embodiments, wherein the curable adhesive film comprises a hot melt processable adhesive. In a twenty-sixth embodiment, the present disclosure provides the article of any one of the first to twenty-fifth embodiments, wherein the unsaturated free-radically polymerizable groups are in a species other than the polymer, and wherein the polymer does not comprise unsaturated free-radically polymerizable groups.

In a twenty-seventh embodiment, the present disclosure provides the article of any one of the first to twenty-sixth embodiments, wherein the oxygen-permeable liner comprises at least one of paper or a polyolefin. In a twenty-eighth embodiment, the present disclosure provides the article of any one of the first to twenty-seventh embodiments, wherein the oxygen-permeable liner comprises ridges on at least one surface. In a twenty-ninth embodiment, the present disclosure provides the article of the twenty-eighth embodiment, wherein the curable adhesive film comprises an outer surface bearing channels corresponding to the ridges, wherein the channels are capable of aiding in escape of air during application of the outer surface to a substrate.

In a thirtieth embodiment, the present disclosure provides the article of any one of the first to twenty-ninth embodiments, further comprising a release liner to which the curable adhesive film is releasably attached. In a thirty-first embodiment, the present disclosure provides the article of any one of the first to twenty-ninth embodiments, further comprising a substrate to which the curable adhesive film is attached.

In a thirty-second embodiment, the present disclosure provides a process for making the article of the thirty-first embodiment, the process comprising applying an activator to the substrate, wherein the activator comprises the oxidizing agent, applying an adhesive film directly adjacent the activator on the substrate to provide the curable adhesive film, wherein the adhesive film comprises the film of the polymer, the unsaturated free-radically polymerizable groups, and the transition metal cation, and joining the adhesive film with the oxygen-permeable liner. In a thirty-third embodiment, the present disclosure provides the process of the thirty-second embodiment, further comprising forming the adhesive film on the oxygen-permeable liner, wherein applying the adhesive film directly adjacent the activator is carried out while the adhesive film is attached to the oxygen-permeable liner. In a thirty-fourth embodiment, the present disclosure provides a process for making a bonded article from the article of the thirty-first embodiment, the process comprising removing the oxygen-permeable liner and bonding a second substrate to the curable adhesive film. In a thirty-fifth embodiment, the present disclosure provides the process of the thirty-fourth embodiment, further comprising applying an activator to the second substrate, wherein the activator comprises a second oxidizing agent, wherein the second oxidizing agent is the same or different from the oxidizing agent in the curable adhesive film. In a thirty-sixth embodiment, the present disclosure provides a process for making a bonded article from two articles of the thirty-first embodiment, which are independently selected from each other, the process comprising removing the independently selected oxygen-permeable liners from the two articles and joining the two articles together. In a thirty-seventh embodiment, the present disclosure provides a process for making the article of the thirtieth embodiment, the process comprising applying an activator to the release liner, wherein the activator comprises the oxidizing agent, applying an adhesive film directly adjacent the activator on the release liner to provide the curable adhesive film, wherein the adhesive film comprises the film of the polymer, the unsaturated free-radically polymerizable groups, and the transition metal cation, and joining the adhesive film with the oxygen-permeable liner. In a thirty-eighth embodiment, the present disclosure provides the process of the thirty-seventh embodiment, further comprising forming the adhesive film on the oxygen-permeable liner, wherein applying the adhesive film directly adjacent the activator is carried out while the adhesive film is attached to the oxygen-permeable liner. In a thirty-ninth embodiment, the present disclosure provides a process for making a bonded article from the article of the thirtieth embodiment, the process comprising removing the release liner to provide a first adhesive surface, removing the oxygen-permeable liner to provide a second adhesive surface, bonding the first adhesive surface to a first substrate, and bonding the second adhesive surface to a second substrate. In a fortieth embodiment, the present disclosure provides the process of the thirty-ninth embodiment, further comprising applying an activator to at least one of the first substrate or the second substrate, wherein the activator comprises a second oxidizing agent, wherein the second oxidizing agent is the same or different from the oxidizing agent in the curable adhesive film. In a forty-first embodiment, the present disclosure provides the process of any one of the thirty-second, thirty-third, thirty-fifth, thirty-seventh, thirty-eighth, or fortieth embodiments, wherein each activator is independently a liquid, the process further comprising allowing the activator to dry before applying the adhesive film directly adjacent the activator on the substrate. In a forty-second embodiment, the present disclosure provides the process of any one of the thirty-second, thirty-third, thirty-fifth, thirty-seventh, thirty-eighth, fortieth, or forty-first embodiments, wherein each activator independently comprises a film-forming polymer or oligomer. In a forty-third embodiment, the present disclosure provides the process of any one of the thirty-second, thirty-third, thirty-fifth, thirty-seventh, thirty-eighth, or fortieth to forty-second embodiments, wherein the activator comprises no tackifier, no species comprising unsaturated free-radically polymerizable groups, or both. In a forty-fourth embodiment, the present disclosure provides the process of any one of the thirty-fourth to thirty-sixth embodiments, wherein applying an adhesive film directly adjacent the activator on the substrate is carried out at least 1, 3, or 5 days or at least 1 or 2 weeks before bonding the second substrate to the curable adhesive film, joining the two articles, or bonding the first adhesive surface to the first substrate and bonding the second adhesive surface to the second substrate.

### EXAMPLES

Objects and advantages of this disclosure are further illustrated by the following non-limiting examples, but the particular materials and amounts thereof recited in these examples, as well as other conditions and details, should not be construed to unduly limit this disclosure.

### Test Method

Dynamic Shear Adhesion Test A dynamic overlap shear test was performed at 71° F. (22° C.) using an Insight 30EL load frame (MTS, Eden Prairie, MN). Test specimens were prepared for dynamic shear adhesion using aluminum substrates (Joseph T. Ryerson & Son, Inc., Coon Rapids, MN) (1-inch by 4-inch by 0.064-inch (2.5-cm by 10-cm by 1.6-mm)) that were washed with MEK, then 50/50 water/IPA solution, and then three times with acetone, followed by air-drying for at least 2 minutes. After test specimens were prepared according to the Examples, below, they were loaded into the grips and the crosshead was operated at 10 inches (25.4 cm) per minute, loading the specimen to failure. Stress at break was recorded in units of pounds per square inch (psi) using testing methods disclosed in ASTM D1002. Six specimens were tested for each Example, and the results were averaged and reported.

TABLE 1
Materials

| | |
|---|---|
| M1 | A compound prepared as described in Example 1 of U.S. Pat. No. 9,102,774 |
| | (Clapper et al.) |
| AA | Acrylic acid available from Sigma Aldrich, St. Louis, MO, USA |
| IOA | Isooctyl acrylate obtained from 3M Company, St. Paul, MN, USA |
| NVC | N-vinylcaprolactam obtained under the trade designation NVC from BASF |
| | Corporation, Florham Park, NJ, USA |
| AIBN | 2,2′-Azobis(2-methylpropionitrile) obtained under the trade designation VAZO-64 |
| | from E.I. du Pont de Nemours & Company, Wilmington, DE, USA |
| Photoinitiator-1 | 2,2-dimethoxy-1,2-diphenylethan-1-one, obtained under the trade designation |
| | IRGACURE 651 from BASF Corporation |
| CuOAc | Copper (II) acetate monohydrate from Alfa Aesar, Ward Hill, MA, USA |
| Antioxidant-1 | Octadecyl-[3-(3,5-di-tert-butyl-4-hydroxyphenyl)propionate], obtained under the |
| | trade designation IRGANOX 1076 from BASF Corporation |
| HDDA | 1,6-Hexanediol diacrylate available from Sigma Aldrich |
| DTMPTA | Ditrimethylolpropane tetraacrylate (DTMPTA) available under the trade |
| | designation MIRAMER M410 from Miwon Specialty Chemical Co., Ltd., Exton, |
| | PA, USA |
| BTEAC | Benzyltriethylammonium chloride available from Lindau Chemicals, Inc., |
| | Columbia, SC, USA |
| DENSITY | An expandable microsphere obtained under the trade designation DUALITE |
| MODIFIER | U010-185D from Chase Corporation, Westwood, MA, USA |
| MEK | Methyl ethyl ketone, obtained from Avantor Performance Materials, Center |
| | Valley, PA, USA |
| IPA | Isopropyl alcohol, obtained from Sigma Aldrich |
| Acetone | Acetone, obtained from Sigma Aldrich |
| TBEC | Tert-Butylperoxy 2-ethylhexyl carbonate, obtained under the trade designation |
| | LUPEROX TBEC from Arkema Inc., King of Prussia, PA, USA |
| UPUV | A primer for pressure sensitive adhesives, obtained under the trade designation 3M |
| | VHB UNIVERSAL PRIMER UV from 3M Company |
| BP | Black color concentrate mixture consisting of a 50/50 blend of carbon black in |
| | ethylene vinyl acetate copolymer resin obtained under the trade designation 4105 |
| | VAC BLACK from Avient, Avon Lake, OH, USA |
| Polymer 2 | A clear, linear triblock copolymer based on styrene and ethylene/butylene obtained |
| | under the trade designation KRATON FG1901 from Kraton Polymers US LLC, |
| | Houston, TX, USA |
| OB | 2,5-thiophenediylbis(5-tert-butyl-1,3-benzoxazole) obtained under the trade |
| | designation TINOPAL OB from BASF Corporation |
| ATBC | Tributyl acetylcitrate obtained under the trade designation PUROLAN ATBC from |
| | Lanxess, Pittsburgh, PA, USA |
| SI | 2-(3,4-epoxycyclohexyl)ethyltrimethoxysilane obtained under the trade |
| | designation SILQUEST A186 SILANE from Momentive, Columbus, OH, USA |
| Oxygen- | Silicone-coated 78# polycoated Kraft paper release liner having a nominal |
| Permeable Liner | thickness of 0.15 mm, available as the standard release liner on 3M ADHESIVE |
| | TRANSFER TAPE 9667MP (3M Company) |
| R-PET | Silicone-coated polyethylene terephthalate film having a nominal thickness of |
| | 0.002 inch (50 micrometers). |

### Preparations

### Preparation of Acrylate Ester Polymer

A terpolymer consisting of iso-octyl acrylate/N-vinylcaprolactam/acrylic acid (IOA/NVC/AA) in a weight ratio of 78:20:2 was prepared as follows. To a 237-milliliter (mL) narrow-mouthed bottle were added 39 grams of IOA, 10 grams of NVC, 1 gram of AA, 0.1 gram AIBN, and 75 grams of ethyl acetate. The resulting solution was purged with dry argon for three minutes and sealed. The sealed bottle was then tumbled in a rotating water bath at 55° C. for 24 hours. The percentage of conversion was determined to be 99.1% by infrared spectrophotometric analysis. The solution had a viscosity of about 7500 centipoise (cps). The inherent viscosity was determined to be about 0.72 deciliters/gram (dl/g) using a Cannon-Fenske #50 viscometer in a water bath controlled at 250 C to measure the flow time of 10 mL of polymer solution (0.15 g of polymer per deciliter of ethyl acetate).

Preparation of Adhesive Film 1 on Oxygen-Permeable Liner Adhesive Film 1 was made by combining a polymer and a liquid blend. The polymer was prepared as described in Synthesis Example S1 of U.S. Pat. Pub. No. 2013/0184394 A1 (Satrijo et al.) except that the pre-adhesive composition was as follows: 89.480 weight percent M1, 9.942 weight percent AA, 0.149 weight percent Photoinitiator-1, 0.030 weight percent CuOAc, 0.398 weight percent Antioxidant-1, and 0.001 weight percent HDDA. The liquid blend was prepared by using a diaphragm pump (Wilden Pump and Engineering, Grand Terrace, CA, USA) to add 132.8 pounds (lb) (60.2 kilograms (kg)) of DTMPTA to a HM-2.5 basketmill (Hockmeyer Equipment Corporation, Elizabeth City, NC, USA) with 9-spindle hub having been preloaded with clean Zirmil 1.5-millimeter (mm) bead media and equipped with a 0.5-mm Tungsten coated screen and HM-2.5 turbo prop. When addition of DTMPTA was complete, 17.2 lb (7.8 kg) of BTEAC was added to the basketmill using a paddle mixer to incorporate. The mixture was milled for 3 hours at 800 revolutions per minute (rpm) with cooling jacket set at 70° F. (21° C.). Milled material was further diluted by addition of 254.1 lbs (115.3 kg) of DTMPTA for every 45.9 lbs (20.8 kg) of milled material. This diluted material, a liquid blend, was combined at 28.5 weight percent with the polymer described above at 71.5 weight percent as described in Hotmelt Compounding of PSA Adhesive Tape in International Publication No. WO2021/176376 (Kugel et al.) to create Adhesive Film 1 on the Oxygen-Permeable Liner.

### Preparation of Adhesive Film 2 Between Oxygen-Permeable Liners

Adhesive Film 2 was assembled by laying Adhesive Film 1, described above, adhesive side-up on a horizontal surface. A second layer of Adhesive Film 1 was applied by rolling the oxygen-permeable liner-backed Adhesive Film 1 down onto the exposed flat surface of the first layer with a 2-inch (5.1-cm) firm rubber roller (MARSHALLTOWN, Marshalltown, IA). After the initial contact was made the rubber roller was used to roll the entire surface so that air bubbles between the two layers were minimized and full contact was ensured. The top oxygen-permeable liner was removed, and this process was repeated until a laminate construction containing seven adhesive film layers was obtained. The final construction was seven layers of Adhesive Film 1 between two of the oxygen-permeable liners.

### Preparation of Multilayer Adhesive Film on Oxygen-Permeable Liner

A three-layer co-extruded tape was prepared by co-extruding a first and second adhesive film layers onto the opposing sides of a foam support layer. The composition of the foam support layer was 68.74 weight percent polymer used in preparation of Adhesive Film 1, 28.5 weight percent liquid blend used in preparation of Adhesive Film 1, 2.00 weight percent DENSITY MODIFIER, 0.76 weight percent BP. The composition of the first and second adhesive films was 70.71 weight percent polymer used in preparation of Adhesive Film 1, 28.5 weight percent liquid blend used in preparation of Adhesive Film 1, and 0.79 weight percent BP. The total thickness of the tape from the three-layer multi manifold film die was 12 mil (0.30 mm). The three-layer co-extruded tape was cast between a silicone coated casting roll and the Oxygen-Permeable Liner entrained by a second chill roll. The chill rolls were cooled with water at a temperature of about 13° C. Once cooled down, the co-extruded tape left the silicone release coated roll thereby adhering to the Oxygen-Permeable Liner and was then rolled up in a winding station.

### Preparation of Activator 1

A 5-liter flask equipped with overhead stirring, thermocouple, condenser, and nitrogen inlet was charged with 100.0 grams Polymer 2, 0.15 gram OB, 48.0 grams ATBC, 120.0 grams Acrylic Ester Polymer and 4.0 grams SI. Stirring was started, 2090 grams of heptane was added, and the mixture was heated 3 hours at 60° C. to ensure homogeneous solution. The solution was cooled to ambient temperature, then sequentially diluted with 1710 grams of methyl acetate and 301.1 grams of TBEC. The final solution was found to have 11.65 weight percent solids.

Preparation of Activator 2 Activator 2 was prepared by mixing 4.0 weight percent TBEC and 96.0 weight percent UPUV in a 40-mL glass vial.

### Preparation of Activated Release Liners

Activator 1 was delivered to R-PET with a 2-mL transfer pipette and hand-coated evenly with RDS #16 Stainless Steel Mayer coating rod (R. D. Specialties, Webster, NY). The activator layer was allowed to dry a minimum of two minutes before using. The Activated Release Liner for Activator 2 was also made the same way.

### EXAMPLES

### Example 1

Example 1 specimens were made by cutting a 1-inch (2.5-cm) strip of Multilayer Adhesive Film on Oxygen-Permeable Liner described above. Aluminum Substrates 1 for the Dynamic Shear Adhesion Test were activated by folding a small lab wipe three times to make about a one-inch strip which was dipped into the Activator 1 solution and wiped from the end of the substrate to the middle so that about two inches was coated. Activated Substrates 1 were allowed to air dry a minimum of two minutes before adhesive application. The Multilayer Adhesive Film previously described was laid across Activated Substrate 1, and the PCK oxygen-permeable liner was left in place. The Multilayer Adhesive Film was trimmed flush with the edges of the substrate forming a 1-inch by 1-inch (2.54-cm by 2.54-cm) bonding area. A 2-inch (5.1-cm) firm rubber roller (MARSHALLTOWN, Marshalltown, IA) was rolled onto the construction with firm hand pressure to ensure full contact of Multilayer Adhesive Film and Activated Substrate 1. Pre-bond specimens made in this way were then stored at room temperature (71° F./22° C.) at times indicated in Table 2 (Pre-Bond Storage Time) before bonds were closed with a second substrate.

Bond assembly occurred by removing the Oxygen-Permeable Liner, exposing the adhesive, and introducing it to a second substrate, Substrate 2, which was not activated with any activator. The closed bond was then subjected to applied pressure of about 20 psi inside a pneumatic driven hydraulic press (Fred S. Carver, Inc. Hydraulic Equipment, Menomonee Falls, WI) between two rubber gaskets for 15 seconds. The bonded article was dwelled at room temperature (71° F./22° C.) for 3 days prior to testing using the Dynamic Shear Adhesion Test. The results are shown in Table 2.

### Example 2

Example 2 was prepared like Example 1 except the second substrate, Substrate 2, was also activated with Activator 1 using the method described in Example 1, thereby generating the construction with a cross-section depicted in FIG. 4.

Example 3 (Prophetic) Example 3 can be made like Example 1, except bond assembly can be done by combining two of the Example 1 pre-bond specimens (i.e., Multilayer Adhesive Film on Activator 1 on Substrate 1) after removing the two Oxygen-Permeable Liners to generate the construction with a cross-section depicted in FIG. 5.

TABLE 2
Dynamic Shear Adhesion Results for Examples (EX) 1 and 2

| | | Pre-Bond | Dynamic Shear | Percent (%) |
|---|---|---|---|---|
| | | Storage Time, | Adhesion, psi | of Adhesion |
| EX | Activation | t (day) | (N/mm²) | at t = 0 |
| EX | Substrate 1 | 0 (Control) | 571.67 (3.94) | 100% |
| 1 | activated with | 3 | 802.33 (5.53) | 140% |
| | Activator 1 | 7 | 1032.00 (7.12) | 181% |
| | | 14 | 836.33 (5.77) | 146% |
| | | 21 | 687.67 (4.74) | 120% |
| | | 28 | 371.67 (2.56) | 65% |
| | | 35 | 170.00 (1.17) | 30% |
| | | 42 | 195.67 (1.35) | 34% |
| EX | Both Substrate | 0 (Control) | 1091.55 (7.53) | 100% |
| 2 | 1&2 activated | 3 | 1085.67 (7.48) | 99% |
| | with Activator 1 | 7 | 1082.67 (7.46) | 99% |
| | | 14 | 1037.67 (7.15) | 95% |
| | | 21 | 855.15 (5.90) | 78% |
| | | 28 | 519.00 (3.58) | 48% |
| | | 35 | 272.00 (1.88) | 25% |
| | | 42 | 248.67 (1.71) | 23% |

### Example 4

Multilayer Adhesive Film on Oxygen-Permeable Liner was laminated onto Activated Release Liner activated with Activator 1 as described above with a 6-inch Silicone-Polymer Blue-S™ Handheld roller (Polymag® Tek Incorporated, Rochester, NY) with firm hand pressure to form the Article 200a shown in FIG. 6. The Article 200a was stored at room temperature (71° F./22° C.) at times indicated in Table 3 (Storage Time) before forming bonds to two substrates activated with Activator 1 as described in Examples 1 and 2. A 1-inch (2.5-cm) strip of Article 200a was cut, and the bond making method was done as described in Examples 1 and 2, with the Activated Release Liner side of Article 200s bonded onto Activated Substrate 1, and the Oxygen-Permeable Liner side introduced to Activated Substrate 2. The control set of Example 4 at t=0 was made like Example 2.

### Example 5

Example 5 was prepared as described in Example 4, except using Adhesive Film 2 between Oxygen-Permeable Liners described above. One Oxygen-Permeable Liner was removed, and Adhesive Film 2 was laminated onto an Activated Release Liner activated with Activator 2 as described in Example 4. Resulting Article 200a was dwelled at room temperature (71° F./22° C.) for 7 days before forming bonds to two substrates activated with Activator 2. The control set of Example 5 at t=0 was created as described in Example 2, except using Adhesive Film 2 to bond Substrates 1 and 2 and Activator 2 described above to activate Substrates 1 and 2, and the bond was dwelled at room temperature (71° F. /22° C.) for 7 days prior to testing.

TABLE 3
Dynamic Shear Adhesion Results for Examples (EX) 4 and 5

| | | | | Percent |
|---|---|---|---|---|
| | | Storage | Dynamic Shear | (%) of |
| | | Time, t | Adhesion, psi | Adhesion |
| | Activation | (day) | (N/mm²) | at t = 0 |
| Exam- | Activated | 0 (Control) | 1091.55 (7.53) | 100% |
| ple 4 | release liner and | 7 | 1138.00 (7.85) | 104% |
| | both Substrate | 14 | 1053.33 (7.26) | 96% |
| | 1&2 activated | 21 | 844.67 (5.82) | 77% |
| | with Activator 1 | 28 | 633.67 (4.37) | 58% |
| Exam- | Activated | 0 (Control) | 175.50 (1.21)* | 100% |
| ple 5 | release liner and | 7 | 760.17 (5.24)* | 433% |
| | both Substrate | | | |
| | 1&2 activated | | | |
| | with Activator 2 | | | |

*The pull rate was 1 inch (2.54 cm)/minute instead of 10 inches (25.4 cm)/minute.

The preceding description, given in order to enable one of ordinary skill in the art to practice the claimed disclosure, is not to be construed as limiting the scope of the disclosure, which is defined by the claims and all equivalents thereto.

1. An article comprising:
a curable adhesive film comprising:
a film of a polymer;
unsaturated free-radically polymerizable groups, which may be bonded to the polymer or in a species other than the polymer;
a transition metal cation; and
an oxidizing agent, and
an oxygen-permeable liner on at least one side of the curable adhesive film.

2. The article of claim 1, wherein the curable adhesive film further comprises a quaternary ammonium salt.

3. The article of claim 1, wherein the curable adhesive film is a first layer of a multilayer curable adhesive film, wherein the multilayer curable adhesive film further comprises a foam support layer.

4. The article of claim 3, wherein the foam support layer is curable.

5. The article of claim 3, wherein the multilayer curable adhesive film further comprises a second layer comprising:
a second film of a second independently selected polymer;
second independently selected unsaturated free-radically polymerizable groups, which may be bonded to the second independently selected polymer or in a second species other than the second independently selected polymer, and
a second independently selected transition metal cation.

6. The article of claim 1, wherein the curable adhesive film is stable at room temperature for at least two weeks.

7. The article of claim 1, wherein the oxygen-permeable liner comprises at least one of paper or a polyolefin.

8. The article of claim 1, wherein the oxygen-permeable liner comprises ridges on at least one surface.

9. The article of claim 1, further comprising a release liner to which the curable adhesive film is releasably attached or further comprising a substrate to which the curable adhesive film is attached.

10. A process for making the article of claim 9, the process comprising:
applying an activator to the substrate or the release liner, wherein the activator comprises the oxidizing agent;
applying an adhesive film directly adjacent the activator on the substrate or the release liner to provide the curable adhesive film, wherein the adhesive film comprises the film of the polymer, the unsaturated free-radically polymerizable groups, and the transition metal cation; and
joining the adhesive film with the oxygen-permeable liner.

11. A process for making a bonded article from the article of claim 9 comprising the substrate to which the curable adhesive film is attached, the process comprising:
removing the oxygen-permeable liner; and
bonding a second substrate to the curable adhesive film.

12. The process of claim 11, further comprising applying an activator to the second substrate, wherein the activator comprises a second oxidizing agent, wherein the second oxidizing agent is the same or different from the oxidizing agent in the curable adhesive film.

13. The process of claim 11, wherein there are two articles, each independently comprising the curable adhesive film, the oxygen-permeable liner, and the substrate to which the curable adhesive film is attached, the process comprising:
removing the oxygen-permeable liner from each of the two articles; and
joining the curable adhesive films of the two articles together to make the bonded article.

14. The process of claim 10, wherein the article comprises the release liner, the process further comprising:
removing the release liner to provide a first adhesive surface;
removing the oxygen-permeable liner to provide a second adhesive surface;
bonding the first adhesive surface to a first substrate; and
bonding the second adhesive surface to a second substrate.

15. The process of claim 14, further comprising applying an activator to at least one of the first substrate or the second substrate, wherein the activator comprises a second oxidizing agent, wherein the second oxidizing agent is the same or different from the oxidizing agent in the curable adhesive film.

16. The process of claim 10, wherein applying the adhesive film directly adjacent the activator on the substrate is carried out at least one day before removing the oxygen-permeable liner and bonding a second substrate to the curable adhesive film.

17. The process of claim 10, wherein the activator is applied to the release liner.

18. The article of claim 8, wherein the curable adhesive film comprises an outer surface bearing channels corresponding to the ridges.

19. The article of claim 4, wherein the foam support layer comprises a base polymer which is the same as the polymer in the curable adhesive film.

20. The article of claim 1, further comprising a release liner to which the curable adhesive film is releasably attached.
